(19) United States
(12) Patent Application Publication
(10) Pub. No.: US 2018/0113834 A1
(43) Pub. Date: Apr. 26, 2018

(54) EFFICIENT MEANS OF TRIGGERING LOGICAL DEVICES ON A RADIO FREQUENCY FRONT END BUS

(71) Applicant: QUALCOMM Incorporated, San Diego, CA (US)

(72) Inventors: Helena Deirdre O'SHEA, San Diego, CA (US); Ryan Scott Castro SPRING, San Diego, CA (US); Satheesha RANGEGOWDA, San Diego, CA (US); ZhenQi CHEN, Shirley, MA (US); Lalan Jee MISHRA, San Diego, CA (US); Richard Dominic Wietfeldt, San Diego, CA (US); Kevin Hsi Huai WANG, San Diego, CA (US)

(21) Appl. No.: 15/792,106

(22) Filed: Oct. 24, 2017

Related U.S. Application Data
(60) Provisional application No. 62/413,363, filed on Oct. 26, 2016.
(60) Provisional application No. 62/477,291, filed on Mar. 27, 2017.
(60) Provisional application No. 62/511,050, filed on May 25, 2017.

(51) Int. Cl. G06F 13/42

(52) U.S. Cl. CPC G06F 13/4282; G06F 2213/0012

(57) ABSTRACT

Methods and apparatuses are described that facilitate data communication across a serial bus. In one configuration, a transmitter configures a plurality of devices by assigning one or more trigger registers to each device of the plurality of devices and sends to each device a trigger register assignment command indicating a trigger register assigned to a device and identifying a trigger corresponding to the device. The transmitter then addresses a packet to an assigned trigger register and generates a bit-index field in the packet. Bits in the bit-index field respectively represent triggers corresponding to devices associated with the assigned trigger register, wherein each bit indicates whether one or more corresponding devices are enabled for operation. The transmitter then sends the packet to the plurality of devices via the serial bus.

### CROSS-REFERENCE TO RELATED APPLICATIONS

This application claims priority to and the benefit of U.S. Provisional Patent Application No. 62/413,363, filed on Oct. 26, 2016, U.S. Provisional Patent Application No. 62/477,291, filed on Mar. 27, 2017, and U.S. Provisional Patent Application No. 62/511,050, filed on May 25, 2017, the entire contents of which are incorporated herein by reference.

### BACKGROUND

### Field

The present disclosure relates generally to communication devices, and more particularly, to communications links connecting integrated circuit devices within an apparatus.

### Background

Serial interfaces have become the preferred method for digital communication between integrated circuit (IC) devices in various apparatus. For example, mobile communications equipment may perform certain functions and provide capabilities using IC devices that include radio frequency transceivers, cameras, display systems, user interfaces, controllers, storage, and the like. General-purpose serial interfaces known in the industry, including the Inter-Integrated Circuit (I2C or I²C) serial bus and its derivatives and alternatives, including interfaces defined by the Mobile Industry Processor Interface (MIPI) Alliance, such as I3C and the Radio Frequency Front End (RFFE) interface.

In one example, the I2C serial bus is a serial single-ended computer bus that was intended for use in connecting low-speed peripherals to a processor. Some interfaces provide multi-master buses in which two or more devices can serve as a bus master for different messages transmitted on the serial bus. In another example, the RFFE interface defines a communication interface for controlling various radio frequency (RF) front end devices, including power amplifier (PA), low-noise amplifiers (LNAs), antenna tuners, filters, sensors, power management devices, switches, etc. These devices may be collocated in a single integrated circuit (IC) or provided in multiple IC devices. In a mobile communications device, multiple antennas and radio transceivers may support multiple concurrent RF links Certain functions can be shared among the front end devices and the RFFE interface enables concurrent and/or parallel operation of transceivers using multi-master, multi-slave configurations.

As the demand for improved communications between devices continues to increase, there exists a need for improvements in protocols and methods for managing the interfaces between RF front end devices.

### SUMMARY

Embodiments disclosed herein provide systems, methods, and apparatuses that facilitate the communication of data across a serial bus interface.

In an aspect of the disclosure, a method performed at a transmitter for sending data to a receiver across a serial bus, includes configuring a plurality of devices by assigning one or more trigger registers to each device of the plurality of devices, sending to each device of the plurality of devices, a trigger register assignment command indicating a trigger register assigned to a device and identifying a trigger corresponding to the device, addressing a packet to an assigned trigger register, generating a bit-index field in the packet, wherein bits in the bit-index field respectively represent triggers corresponding to devices associated with the assigned trigger register, and wherein each bit indicates whether one or more corresponding devices are enabled for operation, sending the packet to the plurality of devices via the serial bus, sending a group assignment command to at least one device of the plurality of devices to associate the at least one device with one or more group identifiers, providing a group identifier in the packet, wherein the group identifier identifies devices of different modules, and wherein the bits in the bit-index field further respectively represent triggers corresponding to devices associated with the group identifier, and sending a plurality of trigger data via the serial bus, wherein the plurality of trigger data are enabled by a plurality of triggers, respectively.

In an aspect, at least one device of the plurality of devices remains disabled for operation when the packet contains a group identifier to which the at least one device is not associated. In a further aspect, generating the bit-index field in the packet includes providing a first bit value in each bit location of the bit-index field that corresponds to one or more devices that are to be enabled for operation, and providing a second bit value in each bit location of the bit-index field that corresponds to one or more devices that are to remain disabled for operation.

In an aspect, devices that are logically grouped together are enabled for operation by a same bit in the bit-index field. In a further aspect, at least one device of the plurality of devices remains disabled for operation when the packet is addressed to a trigger register to which the at least one device is not associated.

In another aspect, the bits in the bit-index field of the packet respectively represent the plurality of triggers, and the packet is sent to simultaneously enable the plurality of trigger data based on the bits in the bit-index field.

In another aspect of the disclosure, a transmitter for sending data to a receiver across a serial bus, includes a serial bus interface and a processing circuit. The processing circuit is configured to configure a plurality of devices by assigning one or more trigger registers to each device of the plurality of devices, send to each device of the plurality of devices, a trigger register assignment command indicating a trigger register assigned to a device and identifying a trigger corresponding to the device, address a packet to an assigned trigger register, generate a bit-index field in the packet, wherein bits in the bit-index field respectively represent triggers corresponding to devices associated with the assigned trigger register, and wherein each bit indicates whether one or more corresponding devices are enabled for operation, send the packet to the plurality of devices via the serial bus, send a group assignment command to at least one device of the plurality of devices to associate the at least one device with one or more group identifiers, provide a group identifier in the packet, wherein the group identifier identifies devices of different modules, and wherein the bits in the bit-index field further respectively represent triggers corresponding to devices associated with the group identifier, and send a plurality of trigger data via the serial bus, wherein the plurality of trigger data are enabled by a plurality of triggers, respectively.

In another aspect of the disclosure, a transmitter for sending data to a receiver across a serial bus, includes means for configuring a plurality of devices by assigning one or more trigger registers to each device of the plurality of devices, means for sending to each device of the plurality of devices, a trigger register assignment command indicating a trigger register assigned to a device and identifying a trigger corresponding to the device, means for addressing a packet to an assigned trigger register, means for generating a bit-index field in the packet, wherein bits in the bit-index field respectively represent triggers corresponding to devices associated with the assigned trigger register, and wherein each bit indicates whether one or more corresponding devices are enabled for operation, means for sending the packet to the plurality of devices via the serial bus, means for sending a group assignment command to at least one device of the plurality of devices to associate the at least one device with one or more group identifiers, means for providing a group identifier in the packet, wherein the group identifier identifies devices of different modules, and wherein the bits in the bit-index field further respectively represent triggers corresponding to devices associated with the group identifier, and means for sending a plurality of trigger data via the serial bus, wherein the plurality of trigger data are enabled by a plurality of triggers, respectively.

In an aspect of the disclosure, a method performed at a receiver for receiving data from a transmitter across a serial bus, includes receiving a trigger register assignment command indicating a trigger register address assigned to the receiver and identifying one or more triggers corresponding to the receiver, receiving a packet at the receiver via the serial bus, reading a register address field in the packet, detecting whether the receiver is to be enabled for operation if the register address field includes an assigned trigger register address, wherein the detecting includes reading a bit-index field of the packet to detect whether one or more bits respectively representing the one or more triggers corresponding to the receiver indicates that the receiver is to be enabled for operation, receiving a group assignment command from the transmitter, the group assignment command associating the receiver with the group identifier, receiving a plurality of trigger data via the serial bus, wherein the plurality of trigger data are enabled via a plurality of triggers, respectively, wherein bits in the bit-index field of the packet respectively represent the plurality of triggers, and simultaneously enabling the plurality of trigger data based on the bits in the bit-index field.

In an aspect, the receiver is to be enabled for operation when one or more bit locations of the bit-index field corresponding to the receiver contains a first bit value, and the receiver is to remain disabled for operation when the one or more bit locations of the bit-index field corresponding to the receiver contains a second bit value. In a further aspect, the packet includes a group identifier identifying a group of devices of different modules, wherein the register address field is read when the receiver is associated with the group identifier. In another aspect, the receiver remains disabled for operation when the receiver is not associated with the group identifier, and the receiver remains disabled for operation when the register address field does not contain the assigned trigger register address. In yet another aspect, the plurality of trigger data are simultaneously enabled after a delay common to all devices coupled to the serial bus.

In an aspect of the disclosure, a receiver for receiving data from a transmitter across a serial bus, includes a serial bus interface and a processing circuit. The processing circuit is configured to receive a trigger register assignment command indicating a trigger register address assigned to the receiver and identifying one or more triggers corresponding to the receiver, receive a packet at the receiver via the serial bus, read a register address field in the packet, detect whether the receiver is to be enabled for operation if the register address field includes an assigned trigger register address, wherein the detecting includes reading a bit-index field of the packet to detect whether one or more bits respectively representing the one or more triggers corresponding to the receiver indicates that the receiver is to be enabled for operation, receive a group assignment command from the transmitter, the group assignment command associating the receiver with the group identifier, receive a plurality of trigger data via the serial bus, wherein the plurality of trigger data are enabled via a plurality of triggers, respectively, wherein bits in the bit-index field of the packet respectively represent the plurality of triggers, and simultaneously enable the plurality of trigger data based on the bits in the bit-index field.

In an aspect of the disclosure, a receiver for receiving data from a transmitter across a serial bus, includes means for receiving a trigger register assignment command indicating a trigger register address assigned to the receiver and identifying one or more triggers corresponding to the receiver, means for receiving a packet at the receiver via the serial bus, means for reading a register address field in the packet, means for detecting whether the receiver is to be enabled for operation if the register address field includes an assigned trigger register address, wherein the detecting includes reading a bit-index field of the packet to detect whether one or more bits respectively representing the one or more triggers corresponding to the receiver indicates that the receiver is to be enabled for operation, means for receiving a group assignment command from the transmitter, the group assignment command associating the receiver with the group identifier, means for receiving a plurality of trigger data via the serial bus, wherein the plurality of trigger data are enabled via a plurality of triggers, respectively, wherein bits in the bit-index field of the packet respectively represent the plurality of triggers, and means for simultaneously enabling the plurality of trigger data based on the bits in the bit-index field.

### BRIEF DESCRIPTION OF THE DRAWINGS

FIG. 1 depicts an apparatus that includes an RF front end and that may be adapted according to certain aspects disclosed herein.

FIG. 2 is a block diagram illustrating a device that employs an RFFE bus to couple various front end devices.

FIG. 3 is a diagram that illustrates an example of a system architecture for an apparatus employing a data link between IC devices according to certain aspects disclosed herein.

FIG. 4 is a diagram illustrating the triggering of a primary receiver chain (PRX) and a diversity receiver chain (DRX) on two carriers.

FIG. 5 is a diagram illustrating triggering across different communication technologies.

FIG. 6 is a diagram of an RFFE register space.

FIG. 7 is a diagram illustrating receiver chain modules/circuits on a dual RFFE bus.

FIG. 8 is a diagram illustrating receiver chain modules/circuits on a single RFFE bus.

FIG. 9 illustrates trigger registers, a first set of trigger commands associated with a first group ID, and a second set of trigger commands associated with a second group ID.

FIG. 10 is a diagram illustrating device modules/circuits on a RFFE bus implementing a triggering scheme according to an aspect of the disclosure.

FIG. 11 is a diagram illustrating trigger registers and trigger command sequences associated with a group ID.

FIG. 12 is a diagram illustrating device modules/circuits on a RFFE bus implementing a triggering scheme according to another aspect of the disclosure.

FIG. 13 is a diagram illustrating configuration registers and configuration command sequences according to an aspect of the disclosure.

FIG. 14 is a diagram illustrating a configuration register and configuration command sequences according to another aspect of the disclosure.

FIG. 15 illustrates trigger registers and trigger command sequences associated with a group ID.

FIG. 16 is a diagram illustrating device modules/circuits on a RFFE bus implementing a triggering scheme according to a further aspect of the disclosure.

FIG. 17 is a block diagram illustrating an example of an apparatus employing a processing circuit that may be adapted according to certain aspects disclosed herein.

FIG. 18 is a flow chart of a method of data communication performed at a bus master device adapted in accordance with certain aspects disclosed herein.

FIG. 19 is a flow chart of another method of data communication performed at a bus master device adapted in accordance with certain aspects disclosed herein.

FIG. 20 is a diagram illustrating an example of a hardware implementation for a transmitting apparatus and employing a processing circuit adapted according to certain aspects disclosed herein.

FIG. 21 is a flow chart of a method of data communication performed at a slave device adapted in accordance with certain aspects disclosed herein.

FIG. 22 is a flow chart of another method of data communication performed at a slave device adapted in accordance with certain aspects disclosed herein.

FIG. 23 is a diagram illustrating an example of a hardware implementation for a receiving apparatus and employing a processing circuit adapted according to certain aspects disclosed herein.

FIG. 24 illustrates a timeline detailing device reception of data associated with different triggers in accordance with certain aspects disclosed herein. FIG. 24 further includes a diagram illustrating device modules/circuits on a RFFE bus implementing a triggering scheme in accordance with certain aspects disclosed herein.

FIG. 25 is a diagram illustrating an example of a hardware implementation for a slave device supporting operations in accordance with certain aspects disclosed herein.

FIG. 26 is a flow chart of a method of receiving trigger data and a corresponding trigger from a sending device across a serial bus interface in accordance with certain aspects disclosed herein.

FIG. 27 is a flow chart of a method for receiving data from a sending device across a serial bus in accordance with certain aspects disclosed herein.

FIG. 28 is a diagram illustrating an example of a hardware implementation for a receiving apparatus and employing a processing circuit adapted according to certain aspects disclosed herein.

FIG. 29 is a flow chart of a method of sending data to a receiver across a serial bus interface in accordance with certain aspects disclosed herein.

FIG. 30 is a diagram illustrating an example of a hardware implementation for a sending apparatus and employing a processing circuit adapted according to certain aspects disclosed herein.

FIG. 31 is a flow chart of a method of sending data to a receiver across a serial bus in accordance with certain aspects disclosed herein.

FIG. 32 is a diagram illustrating an example of a hardware implementation for a sending apparatus and employing a processing circuit adapted according to certain aspects disclosed herein.

FIG. 33 is a flow chart of a method of receiving data from a transmitter across a serial bus in accordance with certain aspects disclosed herein.

FIG. 34 is a diagram illustrating an example of a hardware implementation for a receiving apparatus and employing a processing circuit adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Example of an Apparatus with Multiple IC Device Subcomponents

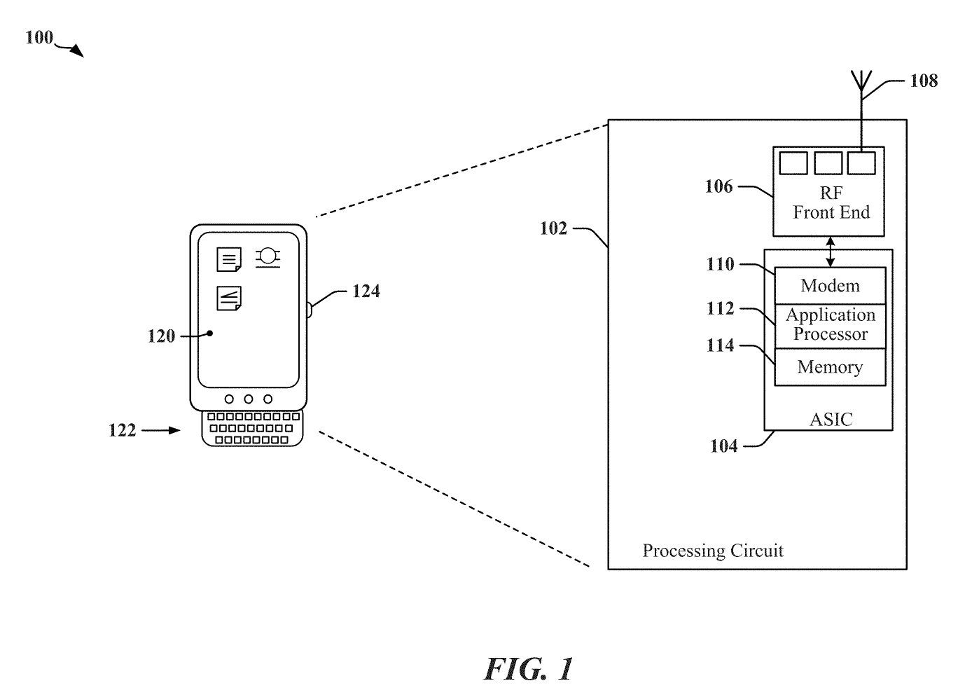

Certain aspects of the invention may be applicable to communications links deployed between electronic devices that include subcomponents of an apparatus such as a telephone, a mobile computing device, an appliance, automobile electronics, avionics systems, etc. FIG. 1 depicts an apparatus 100 that may employ a communication link between IC devices. In one example, the apparatus 100 may be a communication device. The apparatus 100 may include a processing circuit having two or more IC devices 104, 106 that may be coupled using a first communication link One IC device may be include an RF front end 106 that may be operated to enable the apparatus to communicate through one or more transceivers 108 with a radio access network, a core access network, the Internet and/or another network. The RF front end 106 may include a plurality of devices coupled by a second communication link, which may include an RFFE bus.

The processing circuit 102 may include one or more application-specific IC (ASIC) devices. An IC device 104 may include and/or be coupled to one or more processing devices 112, logic circuits, one or more modems 110, and processor readable storage such as a memory device 114 that may maintain instructions and data that may be executed by a processor on the processing circuit 102. The processing circuit 102 may be controlled by one or more of an operating system and an application programming interface (API) layer that supports and enables execution of software modules residing in storage media. The memory device 114 may include read-only memory (ROM) or random-access memory (RAM), electrically erasable programmable ROM (EEPROM), flash cards, or any memory device that can be used in processing systems and computing platforms. The processing circuit 102 may include or have access to a local database or parameter storage that can maintain operational parameters and other information used to configure and operate apparatus 100. The local database may be implemented using one or more of a database module, flash memory, magnetic media, EEPROM, optical media, tape, soft or hard disk, or the like. The processing circuit may also be operably coupled to external devices such as the transceivers 108, a display 120, operator controls, such as a button 124 and/or an integrated or external keypad 122, among other components.

### Overview of the RFFE Bus

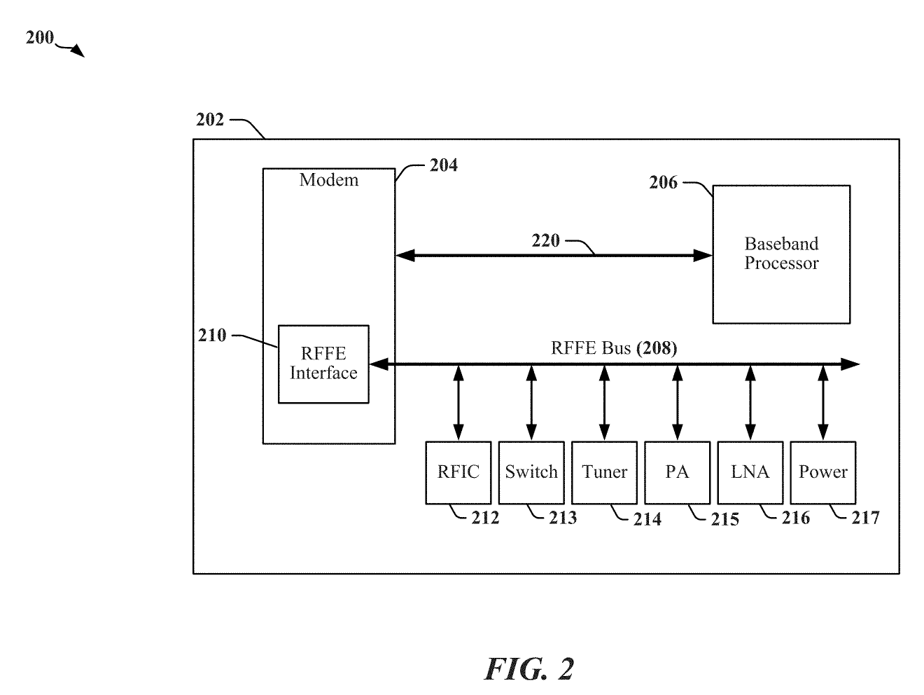

FIG. 2 is a block diagram 200 illustrating an example of a device 202 that employs an RFFE, bus 208 to couple various front end devices 212-217. A modem 204 may also be coupled to the RFFE bus 208. The modem may communicate with a baseband processor 206. The illustrated device 202 may be embodied in one or more of a mobile device, a mobile telephone, a mobile computing system, a telephone, a notebook computer, a tablet computing device, a media player, a gaming device, a wearable computing and/or communications device, an appliance, or the like. In various examples, the device 202 may be implemented with one or more baseband processors 206, modems 204, multiple communications links 208, 220, and various other buses, devices and/or different functionalities.

In the example illustrated in FIG. 2, the RFFE bus 208 may be coupled to an RF integrated circuit (RFIC) 212, which may include one or more controllers, and/or processors that configure and control certain aspects of the RF front end. The RFFE bus 208 may couple the RFIC 212 to a switch 213, an RF tuner 214, a power amplifier (PA) 215, a low noise amplifier (LNA) 216, and a power management module 217.

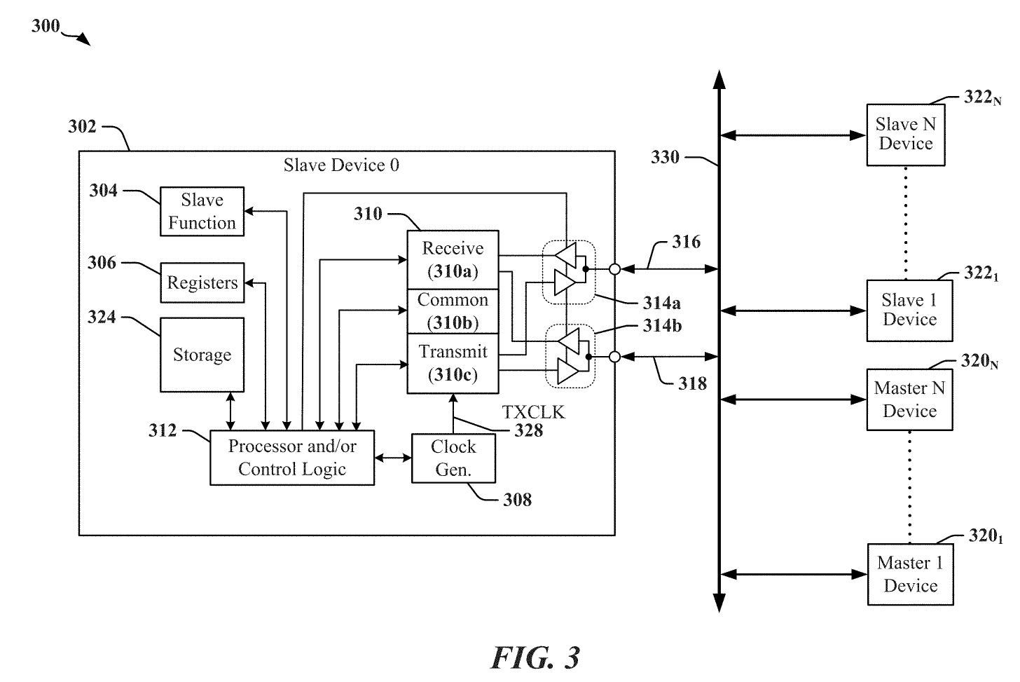

FIG. 3 is a block schematic diagram illustrating an example of an architecture for a device 300 that may employ an RFFE bus 330 to connect bus master devices 320₁-320_{N} and slave devices 302 and 322₁-322_{N}. The RFFE bus 330 may be configured according to application needs, and access to multiple buses 330 may be provided to certain of the devices 320₁-320_{N}, 302, and 322₁-322_{N}. In operation, one of the bus master devices 320₁-320_{N} may gain control of the bus and transmit a slave identifier (slave address) to identify one of the slave devices 302 and 322₁-322_{N} to engage in a communication transaction. Bus master devices 320₁-320_{N} may read data and/or status from slave devices 302 and 322₁-322_{N}, and may write data to memory or may configure the slave devices 302 and 322₁-322_{N}. Configuration may involve writing to one or more registers or other storage on the slave devices 302 and 322₁-322_{N}.

In the example illustrated in FIG. 3, a first slave device 302 coupled to the RFFE bus 330 may respond to one or more bus master devices 320₁-320_{N}, which may read data from, or write data to the first slave device 302. In one example, the first slave device 302 may include or control a power amplifier (see the PA 215 in FIG. 2), and one or more bus master devices 320₁-320_{N} may from time-to-time configure a gain setting at the first slave device 302.

The first slave device 302 may include configuration registers 306 and/or other storage devices 324, a processing circuit and/or control logic 312, a transceiver 310 and a number of line driver/receiver circuits 314a, 314b as needed to couple the first slave device 302 to the RFFE bus 330 (e.g., via a serial clock line 316 and a serial data line 318). The processing circuit and/or control logic 312 may include a processor such as a state machine, sequencer, signal processor or general-purpose processor. The transceiver 310 may include one or more receivers 310a, one or more transmitters 310c and certain common circuits 310b, including timing, logic and storage circuits and/or devices. In some instances, the transceiver 310 may include encoders and decoders, clock and data recovery circuits, and the like. A transmit clock (TXCLK) signal 328 may be provided to the transmitter 310c, where the TXCLK signal 328 can be used to determine data transmission rates.

The RFFE bus 330 is typically implemented as a serial bus in which data is converted from parallel to serial form by a transmitter, which transmits the encoded data as a serial bitstream. A receiver processes the received serial bitstream using a serial-to-parallel convertor to deserialize the data.

### Exemplary Operating Environment for Triggering Devices on an RFFE Bus

Certain aspects disclosed herein relate to triggering logical devices on an RFFE bus. A baseline RFFE bus speed may be limiting when triggering multiple devices on a bus. Triggers associated with each action per IQ path causes bus congestion when there are multiple IQ paths active. Moreover, module designs due to area savings imply that multiple receive paths/transmit paths may be concurrently operational on the same module, which may require multiple triggers that cause congestion. A problem occurs with some modules/circuits in that the modules/circuits process a large number of trigger write commands to enable configuration changes. The problem worsens when a large number of devices covering a large number of RF bands communicate on an RFFE bus. In such a case, the number of critical trigger write commands processed tend to grow with concurrency additions.

In a device, multiple receive paths exist. Accordingly, each individual receive path may be configured using one global trigger signal for that module. When using the global trigger, any receive path associated with the trigger in the module will activate when the trigger is launched. A problem associated with the global trigger relates to each and every receive path needing to receive its own individual setup (configuration). If multiple different receive paths exist, each with different timing, then the problem arises when a receive path is in the middle of its setup (e.g., receiving configuration information) when the global trigger launches. The global trigger unintentionally activates this receive path before the receive path is ready and essentially triggers an incompletely written configuration at the wrong time. This can also have even worse effects that a signal path can be stopped earlier than intended; depending on if a path was being configured to be disabled then the other device can also be stopped earlier than intended.

To overcome the problems associated with triggering multiple devices on the RFFE bus, a scheme is provided that allows for multiple devices to communicate on the bus but avoids the use of multiple individual write commands to trigger each and every path. The scheme facilitates the triggering of only the devices that are intended to be triggered, and thus, prevents other devices not intended to be triggered from unintentionally triggering when a trigger command is sent. For example, the scheme provides for a trigger command that indicates only a particular set of devices (e.g. LNAs) in a module are to be enabled at a given time, and all other devices would know to ignore the trigger command.

Aspects of the disclosure facilitate the prevention of multiple receive paths with different timing from cross corruption and the reduction of trigger pollution. In an aspect, devices belonging together logically are grouped and enabled using one trigger write command. In this manner, only the devices that are intended to be triggered are actually triggered, and therefore, there is no unintended impact to other devices within the same RFFE slave register space.

Advantages are that multiple devices with the same timing can be activated concurrently with a single write command to enable sharing more devices on a common bus. This reduces routing congestion and maintains a low speed to enable multiple blocks concurrently across multiple devices.

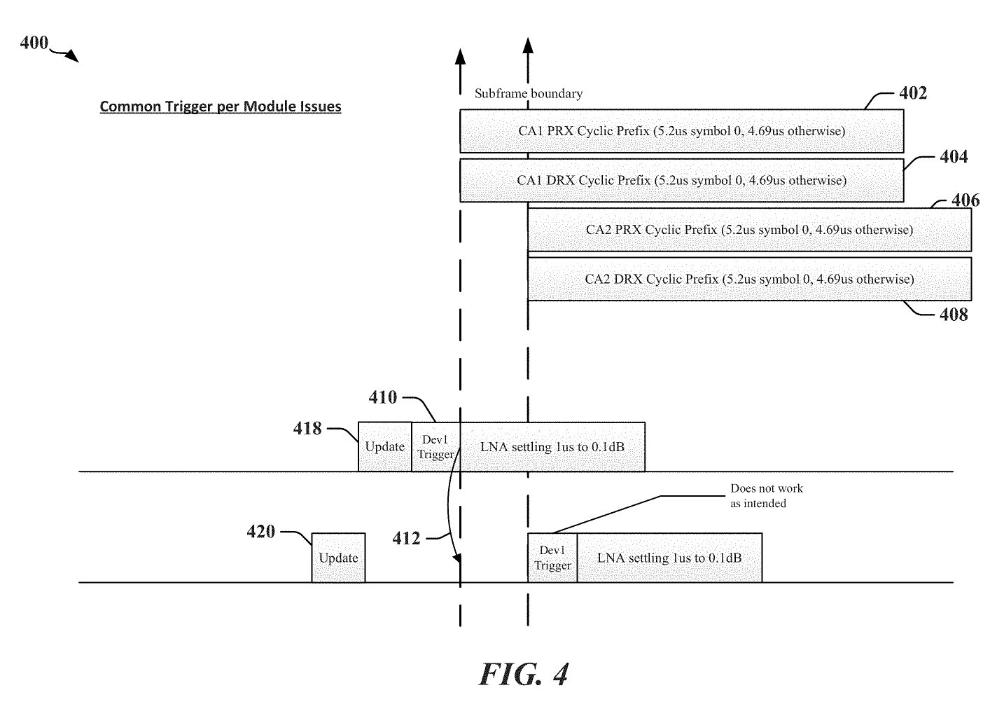

FIG. 4 is a diagram 400 illustrating the triggering of a primary receiver chain (PRX) and a diversity receiver chain (DRX) on two carriers. Emissions are allowed during a cyclic prefix (CP). As shown in FIG. 4, a PRX CP for a first carrier (CA1) 402 and a DRX CP for CA1 404 are staggered in time with respect to a PRX CP for a second carrier (CA2) 406 and a DRX CP for CA2 408.

LNAs for both carriers (CA1 and CA2) may be configured at the same time on a first device (DEV1). However, when a first receive path (CA1) is triggered 410 on DEV1, the triggering also produces the undesirable effect of unintentionally triggering all DEV1 LNAs (DEV1 LNAs for both carriers CA1 and CA2). Thus, a second receive path (CA2) on DEV1 is unintentionally triggered 412 causing all CA2 LNAs on DEV1 to activate outside of an intended CP (cyclic prefix or system provided guard interval) (CA2 PRX CP 406 or CA2 DRX CP 408).

A number of configuration writes may be sent to change/update an RF gain. For example, in FIG. 4, a first configuration write 418 may be sent to change an RF gain of the first receive path (CA1) and a second configuration write 420 may be sent to change an RF gain of the second receive path (CA2). The configuration writes may be launched with a common trigger register. However, as the delay (stagger) between the two carriers increases (up to 30 microseconds), the second configuration write 420 for the second receive path (CA2) may be sent at a time that overlaps with the trigger 410 for the first receive path (CA1). Accordingly, the trigger 410 would unintentionally trigger the second receive path (CA2) with an incompletely written gain state.

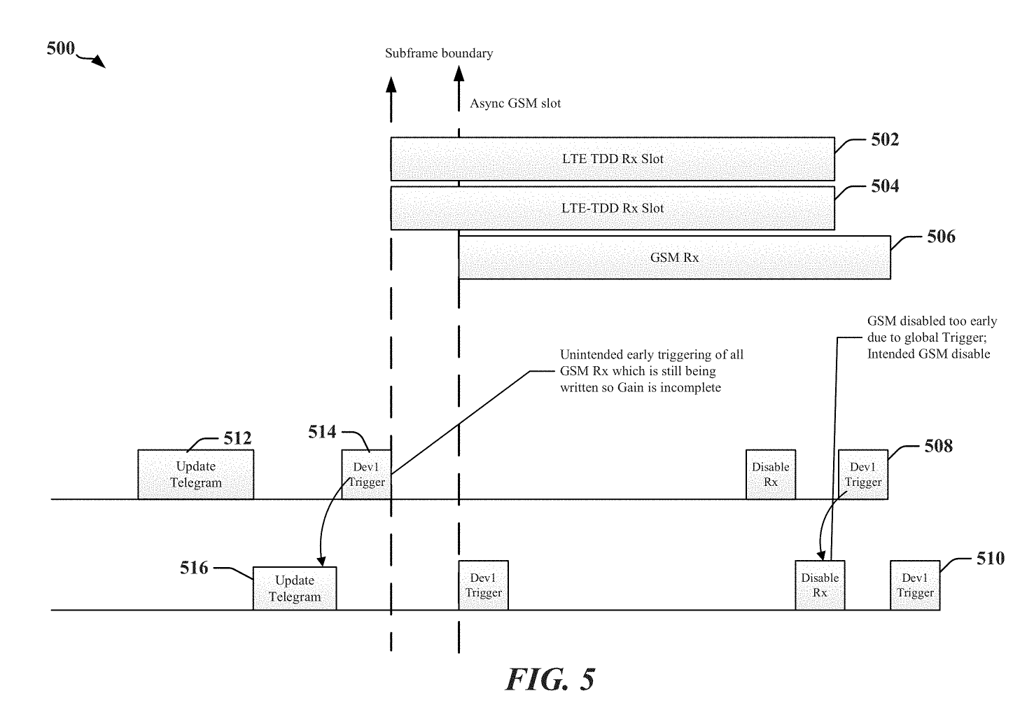

FIG. 5 is a diagram 500 illustrating triggering across different communication technologies. Two different technologies, such as a Long Term Evolution (LTE) system and a Global System for Mobile Communications (GSM), may be operational within a device. As shown in FIG. 5, LTE receive slots 502 and 504 are staggered in time with respect to a GSM receive slot 506.

LTE and GSM receive paths may be enabled to shut down on a device (DEV1) upon receipt of their respective triggers, e.g., first trigger 508 for LTE and second trigger 510 for GSM. However, because of the different timing between the LTE receive path and the GSM receive path, a problem occurs when the first trigger 508 for LTE is sent while the GSM receive path is intended to still be operational. Because the first trigger 508 for LTE is a common (global) trigger, the first trigger 508 unintentionally disables the GSM receive path too early—well before the GSM receive path is intended to be shutdown via the second trigger 510.

A trigger for one technology's receiver chain may be an unintentional early trigger for another technology's receiver chain. For example, as shown in FIG. 5, an LTE configuration 512 is activated by a third trigger 514. However, a GSM configuration 516 is sent during the same time period as the third trigger 514 for the LTE configuration 512. Accordingly, the third trigger 514 (for LTE) unintentionally triggers the GSM receiver chain to be disabled before the disable command was supposed to be executed.

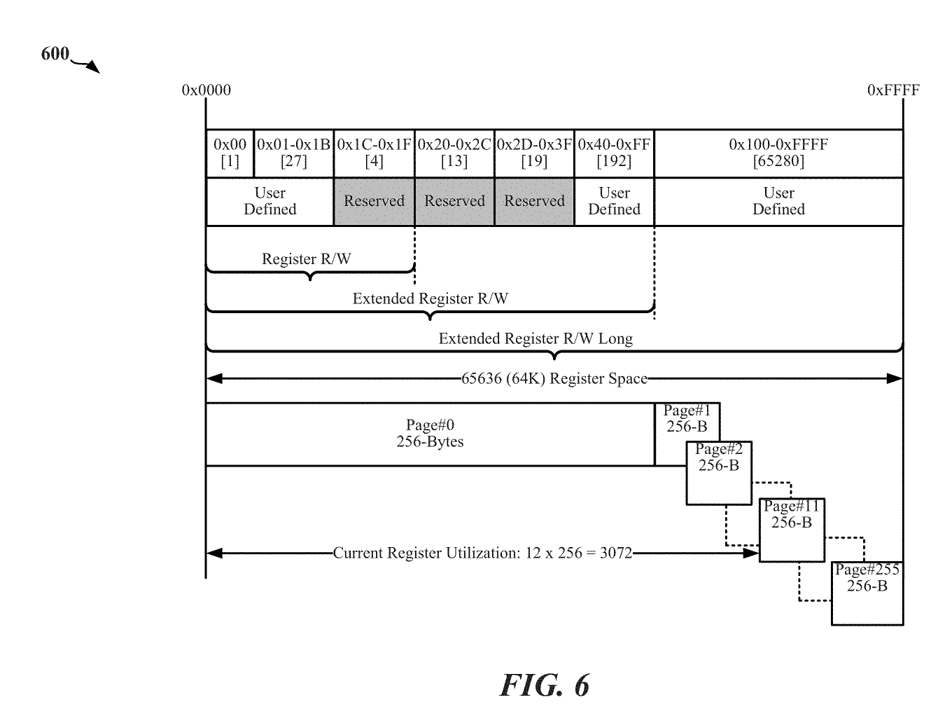

FIG. 6 is a diagram of an RFFE register space 600. The RFFE register space 600 may extend from register 0x0000 to register 0xFFFF in hexadecimal.

An association of commands in terms of register space accessibility is shown in FIG. 6. The reach of an extended register operation may be limited to the space between the 0x00 register and the 0xFF register. However, a complex RFFE slave may contain multiple pages (each having 0x00 to 0xFF 1-byte locations) within the 64K register space, and therefore, enable extended register operation to access the entire 64K register space and reduce bus latency. To achieve this, the 64K register space may be segmented into 256 pages (pages 0x00 to 0xFF), each containing 256 register locations. An 8-bit register address in a datagram combined with a page address allows any register access within the 64K space.

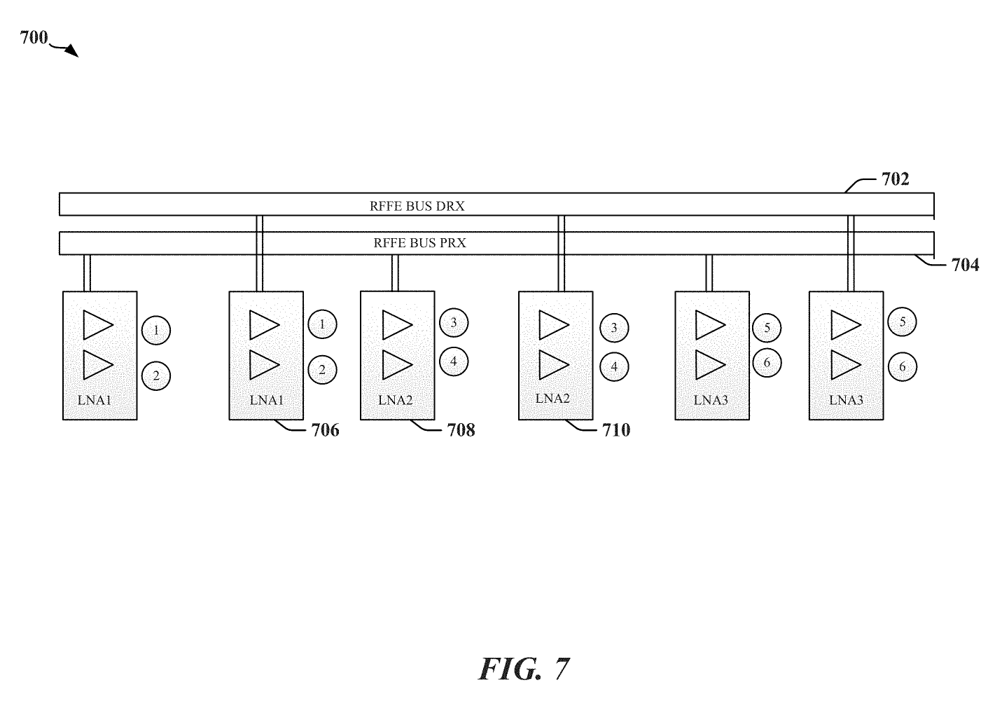

FIG. 7 is a diagram 700 illustrating receiver chain modules/circuits on a dual RFFE bus. Primary receiver chain (PRX) modules/circuits hang off a first bus 702 and diversity receiver chain (DRX) modules/circuits hang off a second bus 704. Each module may include a various number of devices (e.g., LNAs, PAs, etc.). Two trigger registers (TrigReg1 and TrigReg2) may be provided that control up to 16 devices. Each register may include 8 bits. An address for TrigReg1 and TrigReg2 may be common to all devices. TrigReg1 or TrigReg2 may have a bit index for each device as a command index. A group trigger may be utilized to trigger devices across modules/circuits. This implies that a group identifier (ID) (e.g., group slave identifier (GSID)) may apply to registers other than PM-TRIG. Accordingly, PRX and DRX devices may be concurrently triggered with a single write.

In an aspect, a configuration register write may be used to assign each device in a module to one of the two trigger registers via a bitmask. Afterward, a write using one of the two trigger registers (trigger register write) may be sent to indicate via a bitmask whether a device associated with the trigger register is enabled.

For example, devices 1 and 2 may all be within the same module 706 and configured to be associated with a first trigger register. Similarly, these devices can be physically located in different modules/circuits. Thereafter, a first trigger register write may be sent with a bitmask indicating that only device 2 is enabled. Accordingly, only device 2 activates while device 1 remains disabled.

In an aspect, if a group ID is used, devices of other modules/circuits (e.g., module/circuit 708 and/or module/circuit 710) may also be associated with the first trigger register. Thus, devices across different modules/circuits can be controlled using one trigger register write since the devices are grouped together using the group ID. The group ID together with the full extent of the bitmask may be used as a command register to associate devices across modules/circuits to a single trigger register. Another register may also be used to enable each device.

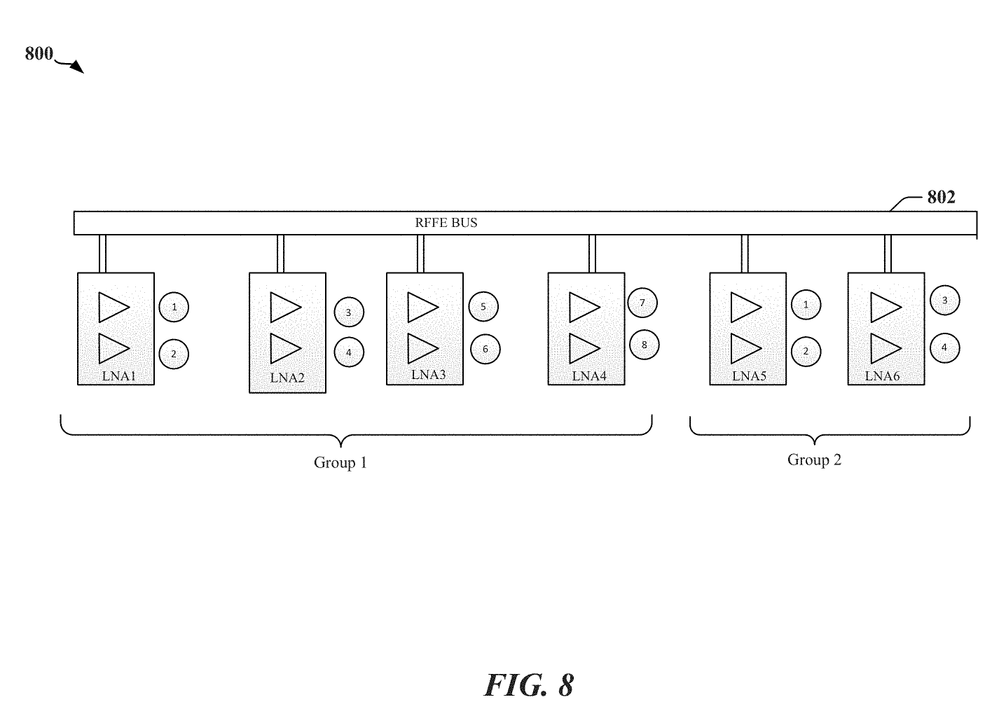

FIG. 8 is a diagram 800 illustrating receiver chain modules/circuits on a single RFFE bus. Primary receiver chain (PRX) modules/circuits and diversity receiver chain (DRX) modules/circuits hang off a single RFFE bus 802. Each module may include a various number of devices (e.g., LNAs, PAs, etc.). Two trigger registers (TrigReg1 and TrigReg2) may be provided that control up to 16 devices. Each register may include 8 bits.

In an aspect, a certain set of devices may be grouped (e.g., by RF band) and associated with a first group ID (e.g., GSID1) while another set of devices may be grouped and associated with a second group ID (e.g., GSID2). Accordingly, devices that are to be enabled may be identified by identifying the particular group ID to be indexed. This allows for the above-described triggering scheme using two trigger registers to extend beyond 16 devices.

Notably, a problem associated with trying to condense more and more devices together within a module is that all the devices may need to trigger at almost the same time. Accordingly, the present disclosure provides for making trigger writes more effective so that the RFFE bus can be used more efficiently.

In an aspect, addresses (e.g., register locations 0x1A and 0x1B) for the first trigger register (TrigReg1) and the second trigger register (TrigReg2) are common to all devices. TrigReg1 or TrigReg2 includes a bit index for each device as a command index. TrigReg1 and TrigReg2 may be command registers. A configuration register, such as EnableCmd Register, may bitmask devices within a module that respond to GSID. A single write to the command address with GSID reduces triggers significantly over modules/circuits.

Benefits increase if a common register for the first trigger and the second trigger is used. Two triggers are sufficient for most cases. However, one trigger using a dynamic GSID may also be used. Device gain states fluctuate at low Ior and higher Ior.

GSID may be used to group low-band devices together, mid-band devices together, and high-band devices together. Two GSIDs may be present in different modules/circuits. There are multiple ways that a GSID can be used to cluster devices together.

An assignment command may mark per unique slave ID (USID) what the GSID covers in terms of which devices are associated. For example: <USID><LNA module index 0><Trigger index>. Alternative implementations of this assignment register are possible. Note that it is possible to indicate that a device is off by using a reserved value to indicate an OFF state.

TrigReg1 or TrigReg2 includes a bit index for each device as a command index. An EnableCmd Register will bitmask the LNAs within a module that respond to GSID.

In an aspect of the disclosure, a scheme for reducing congestion on the RFFE bus is to place PRX and DRX LNAs on a common RFFE bus. To ensure that a module can coexist in a complex system, two trigger registers are provided. A common address may be exploited and GSID will allow extensions as required. Trigger register mapping may be configured at RFFE setup. The mapping of the LNAs can be remapped at any point to reduce the write count.

In another aspect of the disclosure, a scheme for reducing congestion on the RFFE bus is to place PRX and DRX LNAs on separate RFFE buses, and share of the RFFE buses with PAs. A PA and DRX LNA can share a common RFFE bus, which may be facilitated by a bitmap trigger. A PA slot on the RFFE bus may be prioritized over LNA automatic gain control (AGC). An LNA slot update may be moved from Symbol 0 to Symbol 1 to facilitate Tx AGC update.

In an aspect of the disclosure, receiver chain modules/circuits and power amplifiers may share a common RFFE bus. In an example, primary receiver chain (PRX) modules/circuits may hang off a first RFFE bus while diversity receiver chain (DRX) modules/circuits may hang off a second RFFE bus. Each module may include a various number of devices (e.g., LNAs). The PRX LNAs on the first RFFE bus may share the bus with power amplifiers (PAs). The DRX LNAs on the second RFFE bus may share the bus with PAs. The method of reducing trigger telegrams/commands to enable updates ensures that PAs and LNAs can be on a common RFFE bus.

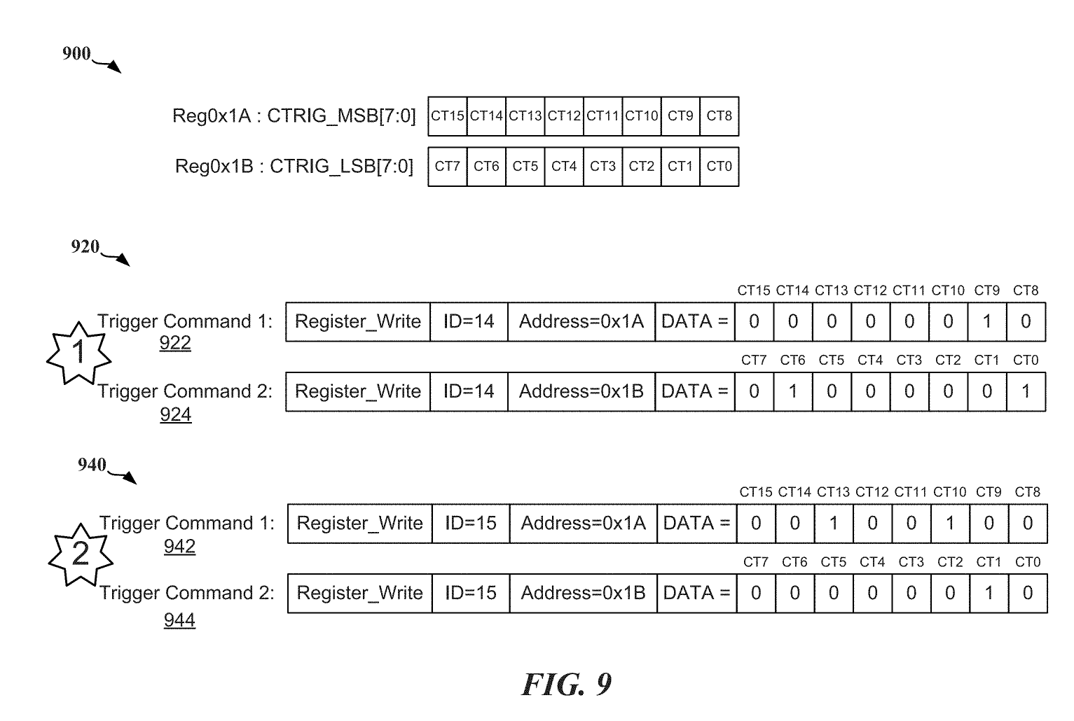

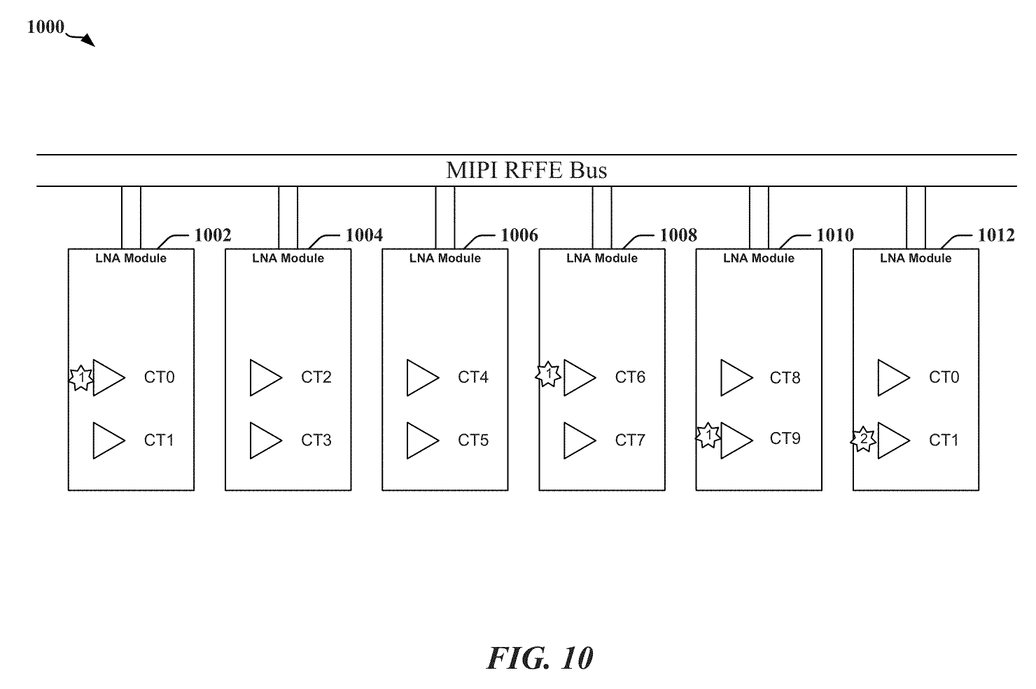

FIGS. 9 and 10 illustrate aspects of a first triggering scheme. FIG. 9 illustrates trigger registers 900, a first set of trigger commands 920 associated with a first group ID, and a second set of trigger commands 940 associated with a second group ID.

According to the first triggering scheme, 16 triggers CT0, CT1, CT2, CT3, CT4, CT5, CT6, CT7, CT8, CT9, CT10, CT11, CT12, CT13, CT14, and CT15 may be defined and allocated between two trigger registers. As shown in FIG. 9, the triggers CT8 to CT15 may be allocated to a first trigger register CTRIG_MSB[7:0] located at register address 0x1A. The triggers CT0 to CT7 may be allocated to a second trigger register CTRIG_LSB[7:0] located at register address 0x1B. Each device (e.g., LNA) on the RFFE bus may be assigned to respond to one of the 16 triggers.

As further shown in FIG. 9, an example first set of trigger commands 920 is associated with a first group ID (e.g., ID=14). A first trigger command 922 associated with the group ID may be a register_write addressed to the first trigger register located at register address 0x1A. In the example, the trigger CT9 is enabled (e.g., set to a value of “1”) in the first trigger command 922. Accordingly, when the first trigger command 922 is sent, the devices associated with the first group ID (ID=14), assigned to respond to the first trigger register (0x1A), and corresponding to the trigger CT9 will be enabled for operation. All other devices remain disabled with respect to the first trigger command 922. A second trigger command 924 associated with the first group ID may be a register_write addressed to the second trigger register located at register address 0x1B. In the example, the triggers CT6 and CT0 are enabled (e.g., set to a value of “1”) in the second trigger command 924. Accordingly, when the second trigger command 924 is sent, the devices associated with the first group ID (ID=14), assigned to respond to the second trigger register (0x1B), and corresponding to the triggers CT6 and CT0 will be enabled for operation. All other devices remain disabled with respect to the second trigger command 924.

An example second set of trigger commands 940 is associated with a second group ID (e.g., ID=15). A first trigger command 942 associated with the second group ID may be a register_write addressed to the first trigger register located at register address 0x1A. In the example, the triggers CT13 and CT10 are enabled (e.g., set to a value of “1”) in the first trigger command 942. Accordingly, when the first trigger command 942 is sent, the devices associated with the second group ID (ID=15), assigned to respond to the first trigger register (0x1A), and corresponding to the triggers CT13 and CT10 will be enabled for operation. All other devices remain disabled with respect to the first trigger command 942. A second trigger command 944 associated with the second group ID may be a register_write addressed to the second trigger register located at register address 0x1B. In the example, the trigger CT1 is enabled (e.g., set to a value of “1”) in the second trigger command 944. Accordingly, when the second trigger command 944 is sent, the device associated with the second group ID (ID=15), assigned to respond to the second trigger register (0x1B), and corresponding to the trigger CT1 will be enabled for operation. All other devices remain disabled with respect to the second trigger command 944.

FIG. 10 is a diagram 1000 illustrating device modules/circuits on a RFFE bus implementing a triggering scheme. Device modules/circuits 1002, 1004, 1006, 1008, and 1010 may include devices that are associated with the first group ID (e.g., ID or GSID=14). Device modules/circuit 1012 may include devices that are associated with the second group ID (e.g., ID or GSID=15).

Each of the device modules/circuits (e.g., LNA modules) 1002, 1004, 1006, 1008, 1010, and 1012 may include a configuration register. The configuration register assigns a first trigger index to a first device in a module/circuit. Other devices in the module/circuit will be assigned a consecutive trigger index starting from the first trigger index in the module/circuit. For example, in a device module/circuit 1002, the configuration register may provide a value of “0”. Accordingly, a first device in the device module/circuit 1002 will be assigned the trigger CT0, the second device in the device module/circuit 1002 will be assigned the trigger CT1, and so forth. In another example, in a device module/circuit 1008, the configuration register may provide a value of “6”. Accordingly, a first device in the device module/circuit 1008 will be assigned the trigger CT6, the second device in the device module/circuit 1006 will be assigned the trigger CT7, and so forth.

Referring to FIGS. 9 and 10, because each device has a unique trigger index, two trigger commands may trigger any combination of devices within the same group ID (ID or GSID). This approach is ultimately flexible. For example, as mentioned above, the first trigger command 922 associated with the first group ID (GSID=14) is a register_write addressed to the first trigger register (0x1A), wherein the trigger CT9 is enabled. Accordingly, when the first trigger command 922 is sent, the second device corresponding to trigger CT9 in the device module/circuit 1010 will be enabled for operation as it is the only device associated with the first group ID (GSID=14), assigned to respond to the first trigger register (0x1A), and has a trigger enabled in the first trigger command 922.

In a further example, as mentioned above, the second trigger command 924 associated with the first group ID (GSID=14) is a register_write addressed to the second trigger register (0x1B), wherein the triggers CT6 and CT0 are enabled. Accordingly, when the second trigger command 924 is sent, the first device corresponding to trigger CT0 in the device module/circuit 1002 and the first device corresponding to trigger CT6 in the device module/circuit 1008 will be enabled for operation as they are the only devices associated with the first group ID (GSID=14), assigned to respond to the second trigger register (0x1B), and have triggers enabled in the second trigger command 924.

In another example, as mentioned above, the first trigger command 942 associated with the second group ID (GSID=15) is a register_write addressed to the first trigger register (0x1A), wherein the triggers CT13 and CT10 are enabled. Accordingly, when the first trigger command 942 is sent, no devices in the device module/circuit 1012 will be enabled for operation since no devices associated with the second group ID (GSID=15), and assigned to respond to the first trigger register (0x1A), have a trigger enabled in the first trigger command 942.

In yet another example, as mentioned above, the second trigger command 944 associated with the second group ID (GSID=15) is a register_write addressed to the second trigger register (0x1B), wherein the trigger CT1 is enabled. Accordingly, when the second trigger command 944 is sent, the second device corresponding to trigger CT1 in the device module/circuit 1012 will be enabled for operation as it is the only device associated with the second group ID (GSID=15), assigned to respond to the second trigger register (0x1B), and has a trigger enabled in the second trigger command 944.

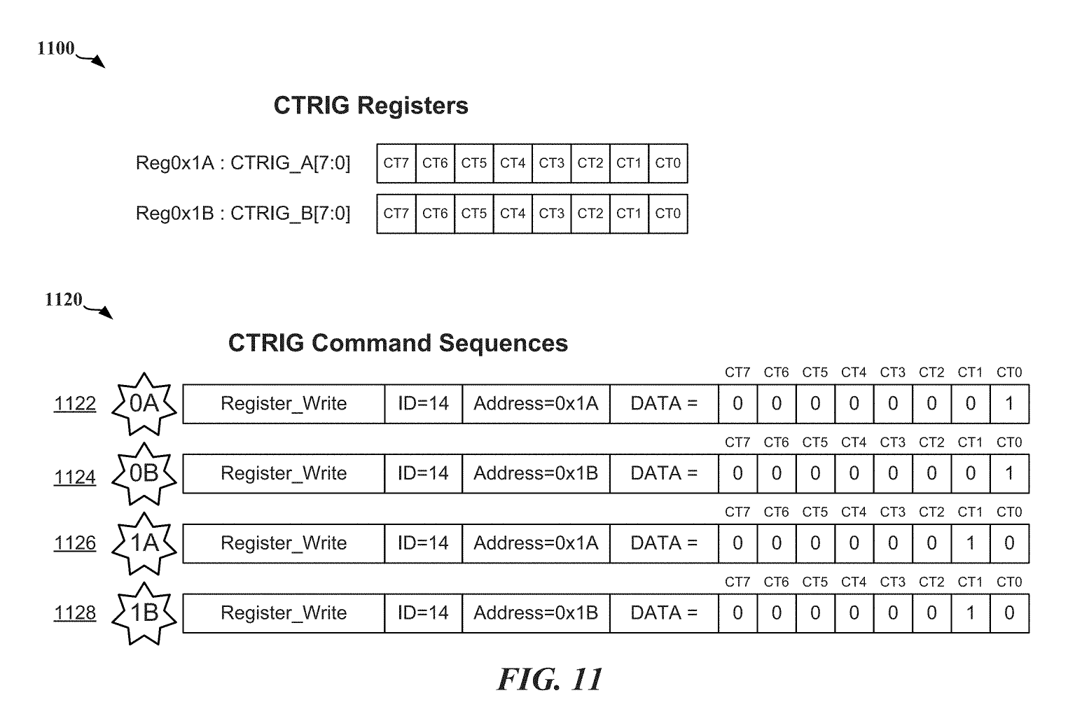

FIGS. 11 to 14 illustrate aspects of a second triggering scheme. FIG. 11 illustrates trigger registers 1100 and trigger command sequences 1120 associated with a group ID.

According to the second triggering scheme, the number of trigger write commands for triggering devices within a group may be reduced to one. Eight triggers CT0, CT1, CT2, CT3, CT4, CT5, CT6, and CT7 may be defined and allocated to two different trigger registers. As shown in FIG. 11, the triggers CT0 to CT7 may be allocated to a first trigger register CTRIG_A[7:0] located at register address 0x1A. The triggers CT0 to CT7 may also be allocated to a second trigger register CTRIG_B [7:0] located at register address 0x1B. Accordingly, each trigger may be sent by two different trigger registers, CTRIG_A(0x1A) and CTRIG_B(0x1B). Each device (e.g., LNA) on the RFFE bus may be assigned to respond to one of the eight triggers.

As further shown in FIG. 11, an example set of trigger commands 1120 is associated with a group ID (e.g., ID=14). A first trigger command 1122 associated with the group ID may be a register_write addressed to the first trigger register located at register address 0x1A (CTRIG_A). In the example, the trigger CT0 is enabled (e.g., set to a value of “1”) in the first trigger command 1122. Accordingly, when the first trigger command 1122 is sent, the devices associated with the group ID (ID=14), assigned to respond to the first trigger register (0x1A), and corresponding to the trigger CT0 will be enabled for operation. All other devices remain disabled with respect to the first trigger command 1122. A second trigger command 1124 associated with the group ID may be a register_write addressed to the second trigger register located at register address 0x1B (CTRIG_B). In the example, the trigger CT0 is enabled (e.g., set to a value of “1”) in the second trigger command 1124. Accordingly, when the second trigger command 1124 is sent, the devices associated with the group ID (ID=14), assigned to respond to the second trigger register (0x1B), and corresponding to the trigger CT0 will be enabled for operation. All other devices remain disabled with respect to the second trigger command 1124.

Moreover, a third trigger command 1126 associated with the group ID may be a register_write addressed to the first trigger register located at register address 0x1A (CTRIG_A). In the example, the trigger CT1 is enabled (e.g., set to a value of “1”) in the third trigger command 1126. Accordingly, when the third trigger command 1126 is sent, the devices associated with the group ID (ID=14), assigned to respond to the first trigger register (0x1A), and corresponding to the trigger CT1 will be enabled for operation. All other devices remain disabled with respect to the third trigger command 1126. A fourth trigger command 1128 associated with the group ID may be a register_write addressed to the fourth trigger register located at register address 0x1B (CTRIG_B). In the example, the trigger CT1 is enabled (e.g., set to a value of “1”) in the fourth trigger command 1128. Accordingly, when the fourth trigger command 1128 is sent, the devices associated with the group ID (ID=14), assigned to respond to the second trigger register (0x1B), and corresponding to the trigger CT1 will be enabled for operation. All other devices remain disabled with respect to the fourth trigger command 1128.

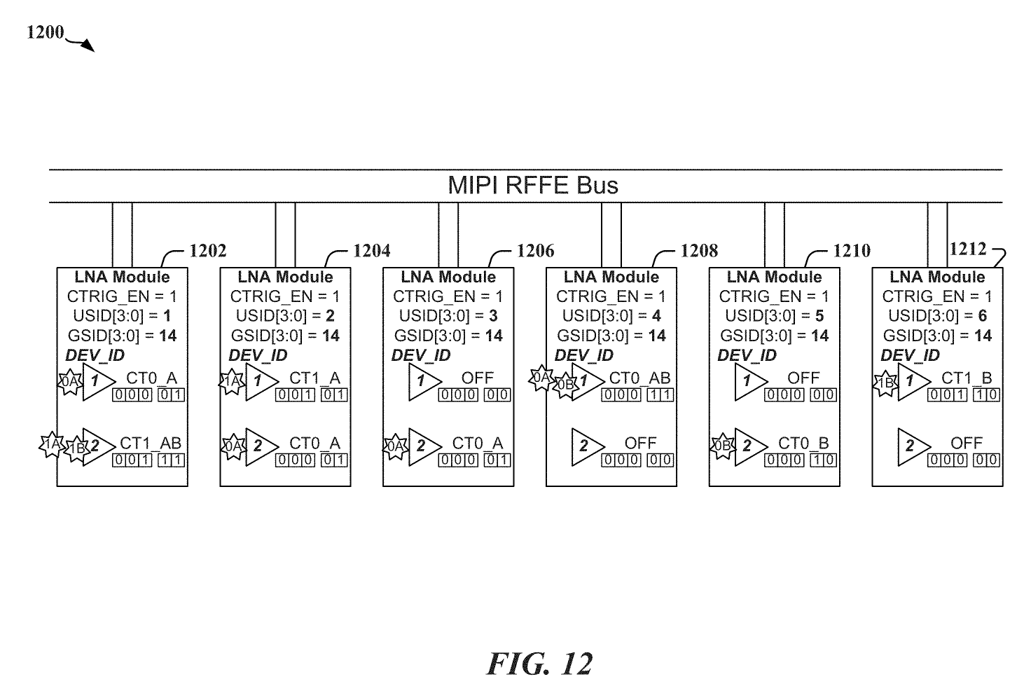

FIG. 12 is a diagram 1200 illustrating device modules/circuits on a RFFE bus implementing a triggering scheme. Device modules/circuits 1202, 1204, 1206, 1208, 1210, and 1212 include devices that are associated with the group ID (e.g., ID or GSID=14). Moreover, each device module/circuit has a unique identifier, e.g., universal slave ID (USID). In FIG. 12, device module/circuit 1202 has USID=1, device module/circuit 1204 has USID=2, device module/circuit 1206 has USID=3, device module/circuit 1208 has USID=4, device module/circuit 1210 has USID=5, and device module/circuit 1212 has USID=6.

Each device (e.g., LNA) within a device module/circuit on the RFFE bus may have a hardcoded device identification (DEV_ID). For example, as shown in FIG. 12, the device module/circuit 1202 includes two devices having DEV_IDs 1 and 2, respectively. In another example, the device module/circuit 1208 includes two devices having DEV_IDs 1 and 2, respectively. In an aspect of the disclosure, each device may be configured via a register_write to a configuration register to enable one of the eight triggers CT0 to CT7. The register_write to the configuration register may also indicate if the device is to respond to a trigger command (CTRIG_A) addressed to the first trigger register (0x1A), a trigger command (CTRIG_B) addressed to the second trigger register (0x1B), both trigger commands (CTRIG_A and CTRIG_B), or none of the trigger commands. Accordingly, one trigger write command for either CTRIG_A or CTRIG_B may trigger all enabled devices that match a trigger index and are enabled to respond to CTRIG_A and/or CTRIG_B.

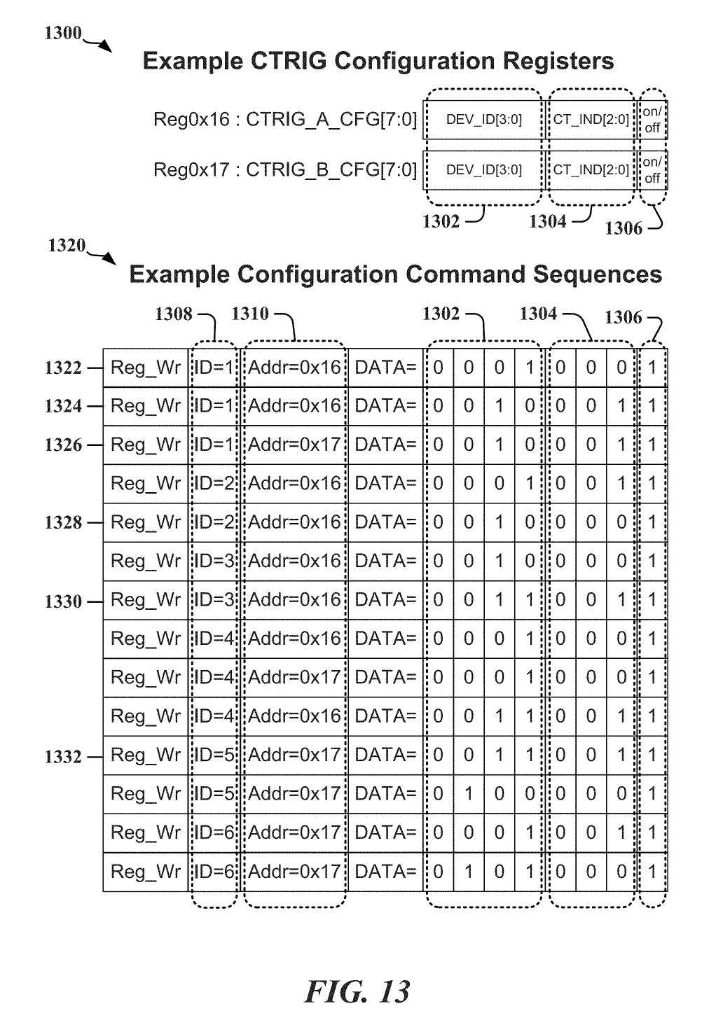

FIG. 13 illustrates configuration registers 1300 and configuration command sequences 1320. Configuration register_writes for configuring a device may be addressed to a first configuration register CTRIG_A_CFG[7:0] located at register address 0x16 and/or a second configuration register CTRIG_B_CFG[7:0] located at register address 0x17. The first configuration register CTRIG_A_CFG (0x16) may be associated with a trigger command (CTRIG_A) addressed to the first trigger register (0x1A) and the second configuration register CTRIG_B_CFG (0x17) may be associated with a trigger command (CTRIG_B) addressed to the second trigger register (0x1B).

The configuration registers include a device identification (DEV_ID) field 1302 for identifying a particular device within a device module/circuit, a trigger indication field 1304 to indicate a specific trigger (CT0 to CT7) for enabling the particular device, and an on/off field 1306 for indicating whether the particular device is to respond to one, both, or none of a trigger command (CTRIG_A) addressed to the first trigger register (0x1A) and a trigger command (CTRIG_B) addressed to the second trigger register (0x1B).

A number of configuration register_writes (configuration command sequences) 1320 may be provided to configure devices on the RFFE bus. Each configuration register-write may include the aforementioned device identification (DEV_ID) field 1302, trigger indication field 1304, and on/off field 1306. Each configuration register-write may further include an ID (or USID) field 1308 for identifying a particular device module/circuit and an address field 1310 for identifying the register address (0x16 or 0x17) being affected by the register_write.

In a first example configuration register_write 1322, the ID field 1308 contains a value of “1”, the DEV_ID field 1302 contains a value of “1”, and the trigger indication field 1304 contains a value of “0”. Referring to FIG. 12, this indicates that within the device module/circuit having the USID=1 (device module/circuit 1202), the device having the DEV_ID=1 is configured to be enabled by the trigger CT0. Moreover, in the configuration register_write 1322, the address field 1310 contains a value of “0x16” and the on/off field 1306 contains the value of “1”. Further referring to FIG. 12, this indicates that within the device module/circuit having the USID=1 (device module/circuit 1202), the device having the DEV_ID=1 is further configured to respond to a trigger command (CTRIG_A) addressed to the first trigger register (0x1A) since the register 0x16 is associated with the first trigger register (0x1A). As such, the device responds to the first trigger command 1122 (FIG. 11) containing the trigger CT0.

Notably, if the on/off field 1306 of the configuration register_write 1322 was to contain a value of “0”, then this would indicate that the device having the DEV_ID=1 is set to an OFF state (i.e., configured not to respond) with respect to the trigger command (CTRIG_A) addressed to the first trigger register (0x1A). Accordingly, the trigger CT0 within the trigger command (CTRIG_A) addressed to the first trigger register (0x1A) may be used/reused to enable another device of a different device module/circuit. For example, in a configuration register_write 1328, wherein the ID field 1308 contains a value of “2” and the DEV_ID field 1302 contains a value of “2”, the trigger indication field 1304 may contain a value of “0”. Referring to FIG. 12, this indicates that within the device module/circuit having the USID=2 (device module/circuit 1204), the device having the DEV_ID=2 may be configured to be enabled by the trigger CT0. Moreover, in the configuration register_write 1328, the address field 1310 may contain a value of “0x16” and the on/off field 1306 may contain the value of “1”. Accordingly, referring to FIG. 12, this indicates that within the device module/circuit having the USID=2 (device module/circuit 1204), the device having the DEV_ID=2 may further be configured to respond to the trigger command (CTRIG_A) addressed to the first trigger register (0x1A) since the register 0x16 is associated with the first trigger register (0x1A). As such, the device having DEV_ID=2 within the device module/circuit 1204 also responds to the first trigger command 1122 (FIG. 11) containing the trigger CT0.

In a second example configuration register_write 1324, the ID field 1308 contains a value of “1”, the DEV_ID field 1302 contains a value of “2”, and the trigger indication field 1304 contains a value of “1”. Referring to FIG. 12, this indicates that within the device module/circuit having the USID=1 (device module/circuit 1202), the device having the DEV_ID=2 is configured to be enabled by the trigger CT1. Moreover, in the configuration register_write 1324, the address field 1310 contains a value of “0x16” and the on/off field 1306 contains the value of “1”. Further referring to FIG. 12, this indicates that within the device module/circuit having the USID=1 (device module/circuit 1202), the device having the DEV_ID=2 is further configured to respond to a trigger command (CTRIG_A) addressed to the first trigger register (0x1A) since the register 0x16 is associated with the first trigger register (0x1A). As such, the device responds to the third trigger command 1126 (FIG. 11) containing the trigger CT1.

Notably, if the on/off field 1306 of the configuration register_write 1324 was to contain a value of “0”, then this would indicate that the device having the DEV_ID=2 is set to an OFF state (i.e., configured not to respond) with respect to the trigger command (CTRIG_A) addressed to the first trigger register (0x1A). Accordingly, the trigger CT1 of the trigger command (CTRIG_A) addressed to the first trigger register (0x1A) may be used/reused to enable another device of a different device module/circuit.

In a third example configuration register_write 1326, the ID field 1308 contains a value of “1”, the DEV_ID field 1302 contains a value of “2”, and the trigger indication field 1304 contains a value of “1”. Referring to FIG. 12, this indicates that within the device module/circuit having the USID=1 (device module/circuit 1202), the device having the DEV_ID=2 is configured to be enabled by the trigger CT1. Moreover, in the configuration register_write 1326, the address field 1310 contains a value of “0x17” and the on/off field 1306 contains the value of “1”. Further referring to FIG. 12, this indicates that within the device module/circuit having the USID=1 (device module/circuit 1202), the device having the DEV_ID=2 is further configured to respond to a trigger command (CTRIG_B) addressed to the second trigger register (0x1B) since the register 0x17 is associated with the second trigger register (0x1B). As such, the device responds to the fourth trigger command 1128 (FIG. 11) containing the trigger CT1.

Notably, if the on/off field 1306 of the configuration register_write 1326 was to contain a value of “0”, then this would indicate that the device having the DEV_ID=2 is set to an OFF state (i.e., configured not to respond) with respect to the trigger command (CTRIG_B) addressed to the second trigger register (0x1B). Accordingly, the trigger CT1 of the trigger command (CTRIG_B) addressed to the second trigger register (0x1B) may be used/reused to enable another device of a different device module/circuit.

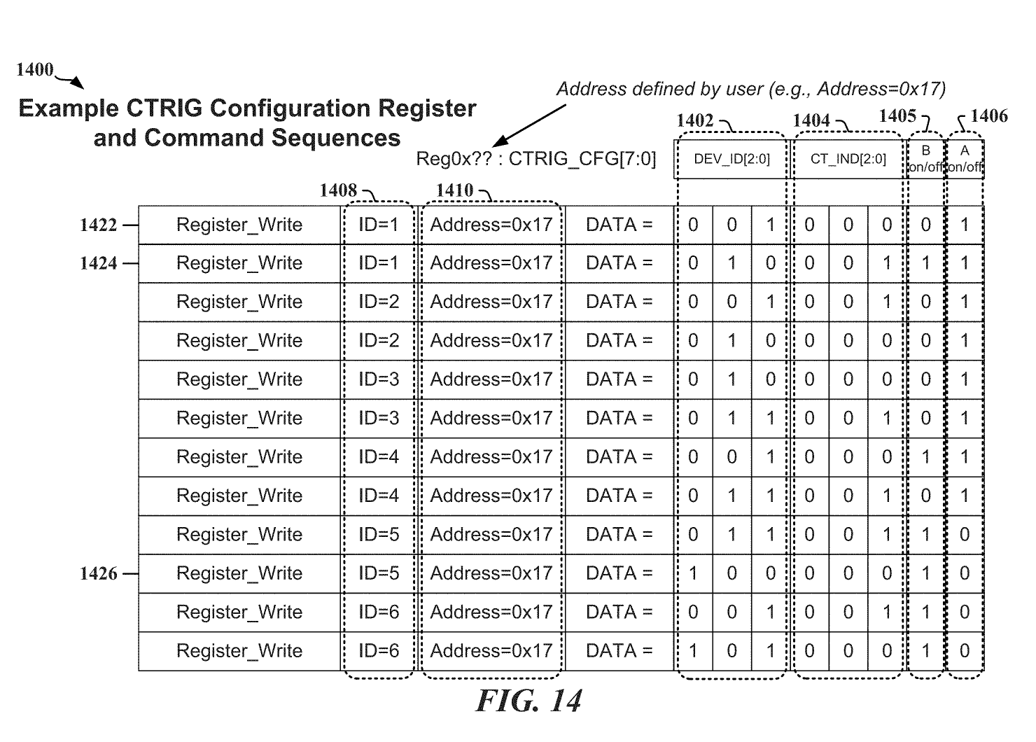

FIG. 14 is a diagram 1400 illustrating a configuration register and configuration command sequences. Configuration register_writes for configuring a device may be addressed to a configuration register as defined by a user. In the example shown, a configuration register CTRIG_CFG[7:0] is located at register address 0x17, however, any register address location may be used. The configuration register CTRIG_CFG may be associated with both a trigger command (CTRIG_A) addressed to the first trigger register (0x1A) and a trigger command (CTRIG_B) addressed to the second trigger register (0x1B).

The configuration register includes a device identification (DEV_ID) field 1402 for identifying a particular device within a device module/circuit, a trigger indication field 1404 to indicate a specific trigger (CT0 to CT7) for enabling the particular device, a B-on/off field 1405 for indicating whether the particular device is to respond to a trigger command (CTRIG_B) addressed to the second trigger register (0x1B), and an A-on/off field 1406 for indicating whether the particular device is to respond to a trigger command (CTRIG_A) addressed to the first trigger register (0x1A). In comparison with the configuration registers of FIG. 13, a width of the DEV_ID field in FIG. 14 is reduced from 4 bits to 3 bits. This allows one less configuration register address to be used in comparison to FIG. 13.

A number of configuration register_writes (configuration command sequences) may be provided to configure devices on the RFFE bus. Each configuration register-write may include the aforementioned device identification (DEV_ID) field 1402, trigger indication field 1404, B-on/off field 1405, and A-on/off field 1406. Each configuration register-write may further include an ID (or USID) field 1408 for identifying a particular device module/circuit and an address field 1410 for identifying the register address (e.g., 0x17) being affected by the register_write.

In a fourth example configuration register_write 1422, the ID field 1408 contains a value of “1”, the DEV_ID field 1402 contains a value of “1”, and the trigger indication field 1404 contains a value of “0”. Referring to FIG. 12, this indicates that within the device module/circuit having the USID=1 (device module/circuit 1202), the device having the DEV_ID=1 is configured to be enabled by the trigger CT0. Moreover, in the configuration register_write 1422, the B-on/off field 1405 contains a value of “0” and the A-on/off field 1406 contains the value of “1”. Further referring to FIG. 12, this indicates that within the device module/circuit having the USID=1 (device module/circuit 1202), the device having the DEV_ID=1 is further configured to respond to a trigger command (CTRIG_A) addressed to the first trigger register (0x1A) since the A-on/off field 1406 is enabled, but is not configured to respond to a trigger command (CTRIG_B) addressed to the second trigger register (0x1B) since the B-on/off field 1405 is disabled. As such, the device responds to the first trigger command 1122 (FIG. 11) containing the trigger CT0.

As noted above, because the B-on/off field 1405 of the configuration register_write 1422 contains a value of “0”, the device having the DEV_ID=1 is set to an OFF state (i.e., configured not to respond) with respect to the trigger command (CTRIG_B) addressed to the second trigger register (0x1B). Accordingly, the trigger CT0 within the trigger command (CTRIG_B) addressed to the second trigger register (0x1B) may be used/reused to enable another device of a different device module/circuit.

In a fifth example configuration register_write 1424, the ID field 1408 contains a value of “1”, the DEV_ID field 1402 contains a value of “2”, and the trigger indication field 1404 contains a value of “1”. Referring to FIG. 12, this indicates that within the device module/circuit having the USID=1 (device module/circuit 1202), the device having the DEV_ID=2 is configured to be enabled by the trigger CT1. Moreover, in the configuration register_write 1422, the B-on/off field 1405 contains a value of “1” and the A-on/off field 1406 contains the value of “1”. Further referring to FIG. 12, this indicates that within the device module/circuit having the USID=1 (device module/circuit 1202), the device having the DEV_ID=2 is further configured to respond to a trigger command (CTRIG_A) addressed to the first trigger register (0x1A) since the A-on/off field 1406 is enabled, and configured to respond to a trigger command (CTRIG_B) addressed to the second trigger register (0x1B) since the B-on/off field 1405 is also enabled. As such, the device responds to both the third trigger command 1126 and the fourth trigger command 1128 (FIG. 11), which both contain the trigger CT1.

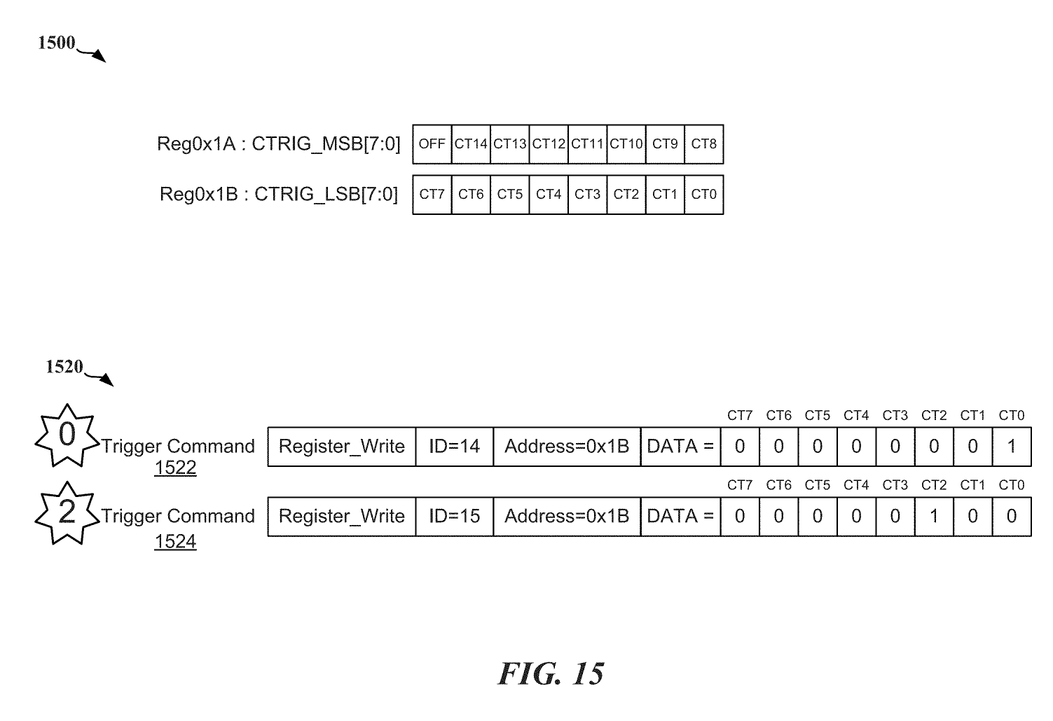

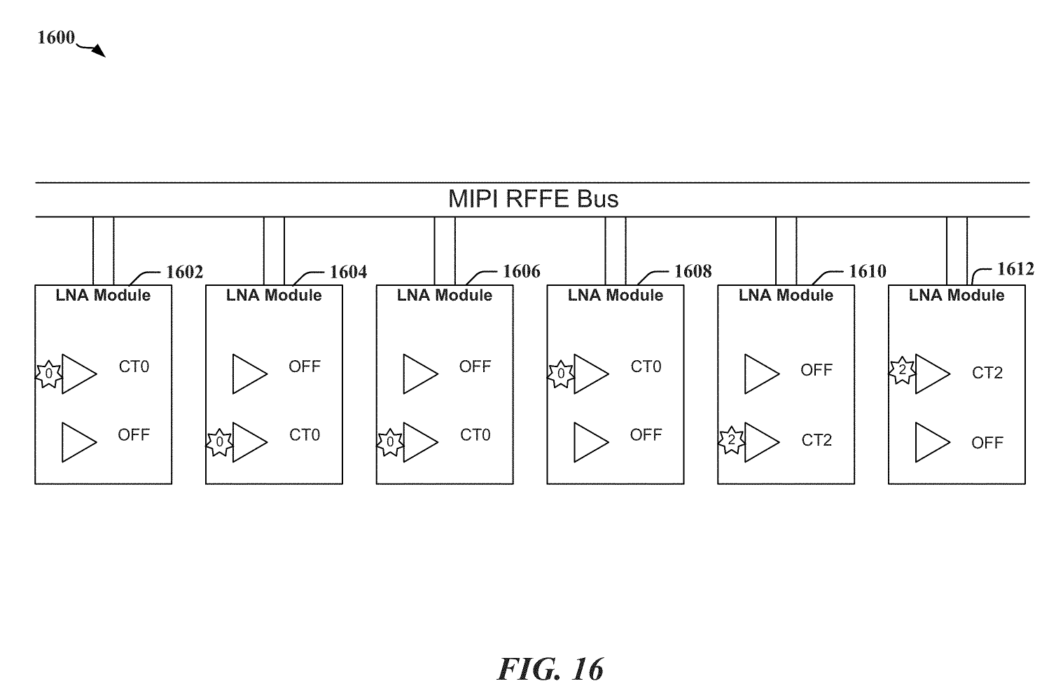

FIGS. 15 and 16 illustrate aspects of a third triggering scheme. FIG. 15 illustrates trigger registers 1500 and trigger command sequences 1520 associated with a group ID.

According to the third triggering scheme, 15 triggers CT0, CT1, CT2, CT3, CT4, CT5, CT6, CT7, CT8, CT9, CT10, CT11, CT12, CT13, and CT14 may be defined and allocated between two trigger registers. As shown in FIG. 15, the triggers CT8 to CT14 may be allocated to a first trigger register CTRIG_MSB[7:0] located at register address 0x1A. One bit location in the first trigger register CTRIG_MSB may be defined to indicate an off-state. The triggers CT0 to CT7 may be allocated to a second trigger register CTRIG_LSB[7:0] located at register address 0x1B. Each device (e.g., LNA) on the RFFE bus may be assigned to respond to one of the 15 triggers.

As further shown in FIG. 15, an example first trigger command 1522 is associated with a first group ID (e.g., ID=14). The first trigger command 1522 associated with the first group ID may be a register_write addressed to the second trigger register located at register address 0x1B. In the example, the trigger CT0 is enabled (e.g., set to a value of “1”) in the first trigger command 1522. Accordingly, when the first trigger command 1522 is sent, the devices associated with the first group ID (ID=14), assigned to respond to the second trigger register (0x1B), and corresponding to the trigger CT0 will be enabled for operation. All other devices remain disabled with respect to the first trigger command 1522.

An example second trigger command 1524 is associated with a second group ID (e.g., ID=15). The second trigger command 1524 associated with the second group ID may be a register_write addressed to the second trigger register located at register address 0x1B. In the example, the trigger CT2 is enabled (e.g., set to a value of “1”) in the second trigger command 1524. Accordingly, when the second trigger command 1524 is sent, the devices associated with the second group ID (ID=15), assigned to respond to the second trigger register (0x1B), and corresponding to the trigger CT2 will be enabled for operation. All other devices remain disabled with respect to the second trigger command 1524.

FIG. 16 is a diagram 1600 illustrating device modules/circuits on a RFFE bus implementing a triggering scheme. Device modules/circuits 1602, 1604, 1606, and 1608 may include devices that are associated with the first group ID (e.g., ID or GSID=14). Device modules/circuits 1610 and 1612 may include devices that are associated with the second group ID (e.g., ID or GSID=15).

Each device within a device module/circuit may include a configuration register to define one trigger index. For example, in the device module/circuit 1602, a first device may include a configuration register containing a value of “0”, and thus defining the trigger index CT0. In another example, in the device module/circuit 1610, a second device may include a configuration register containing a value of “2”, and thus defining a trigger index CT2.

Referring to FIGS. 15 and 16, each device will respond to a trigger write command that contains a matching GSID and matching trigger index. For example, as mentioned above, the first trigger command 1522 associated with the first group ID (GSID=14) is a register_write addressed to the second trigger register (0x1B), wherein the trigger CT0 is enabled. Accordingly, when the first trigger command 1522 is sent, the first device in the device module/circuit 1602 will be enabled for operation as the device is associated with the first group ID (GSID=14) and has a corresponding trigger index CT0 enabled in the first trigger command 1522.

In a further example, as mentioned above, the second trigger command 1524 associated with the second group ID (GSID=15) is a register_write addressed to the second trigger register (0x1B), wherein the trigger CT2 is enabled. Accordingly, when the second trigger command 1524 is sent, the second device in the device module/circuit 1610 will be enabled for operation as the device is associated with the second group ID (GSID=15) and has a corresponding trigger index CT2 enabled in the second trigger command 1524.

### Examples of Processing Circuits and Methods

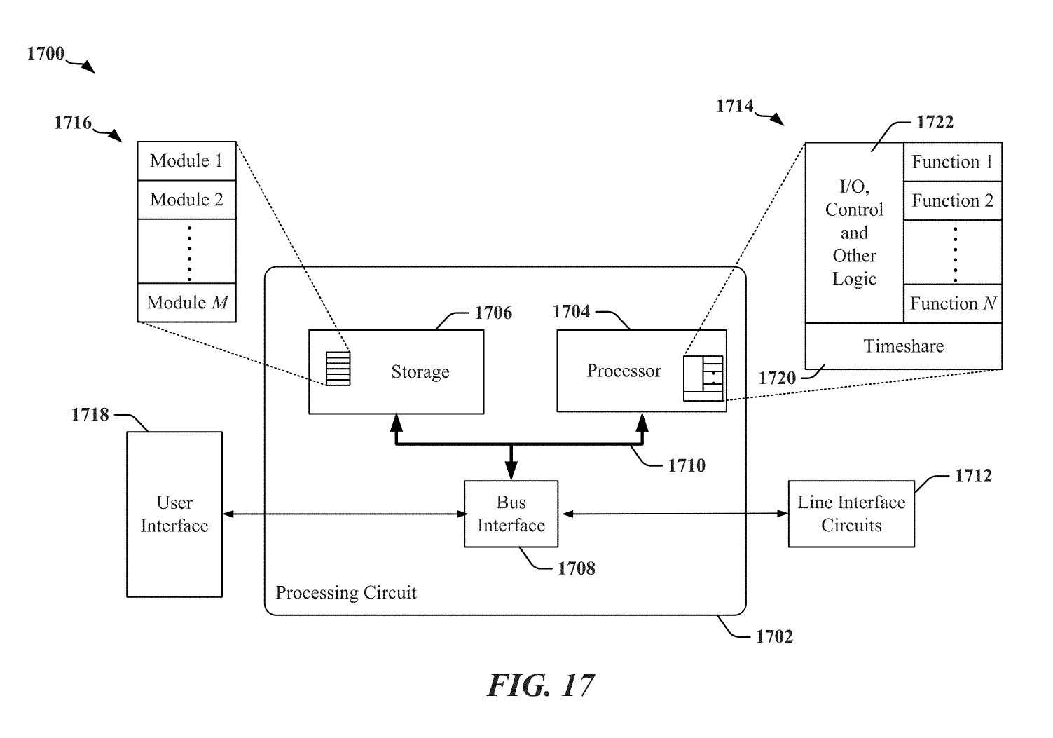

FIG. 17 is a conceptual diagram illustrating an example of a hardware implementation for an apparatus 1700 employing a processing circuit 1702 that may be configured to perform one or more functions disclosed herein. In accordance with various aspects of the disclosure, an element, or any portion of an element, or any combination of elements as disclosed herein may be implemented using the processing circuit 1702. The processing circuit 1702 may include one or more processors 1704 that are controlled by some combination of hardware and software modules. Examples of processors 1704 include microprocessors, microcontrollers, digital signal processors (DSPs), ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices, and may be referred to herein as computer-readable media and/or processor-readable media. The bus 1710 may also link various other circuits such as timing sources, timers, peripherals, voltage regulators, and power management circuits. A bus interface 1708 may provide an interface between the bus 1710 and one or more transceivers 1712. A transceiver 1712 may be provided for each networking technology supported by the processing circuit. In some instances, multiple networking technologies may share some or all of the circuitry or processing modules found in a transceiver 1712. Each transceiver 1712 provides a means for communicating with various other apparatus over a transmission medium. Depending upon the nature of the apparatus 1700, a user interface 1718 (e.g., keypad, display, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a computer-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1706 or in an external computer readable medium. The external computer-readable medium and/or storage 1706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1706 may also include, by way of example, a carrier wave, a transmission line, and any other suitable medium for transmitting software and/or instructions that may be accessed and read by a computer. Computer-readable medium and/or the storage 1706 may reside in the processing circuit 1702, in the processor 1704, external to the processing circuit 1702, or be distributed across multiple entities including the processing circuit 1702. The computer-readable medium and/or storage 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1706 may maintain software maintained and/or organized in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704, and may manage access to external devices such as the transceiver 1712, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to the transceiver 1712, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the transceiver 1712, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

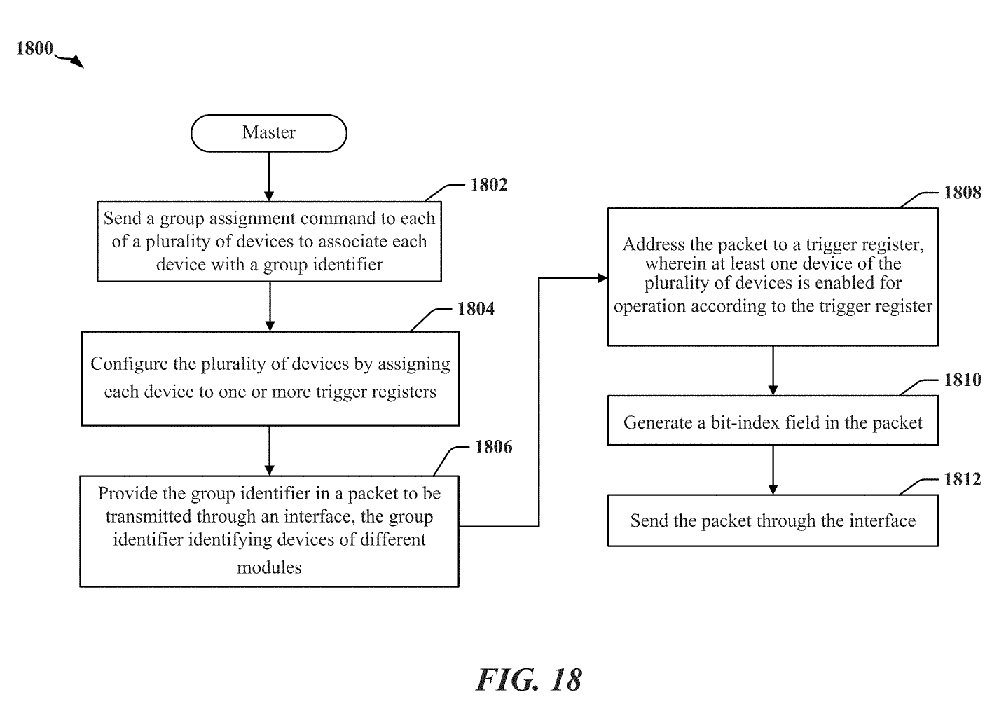

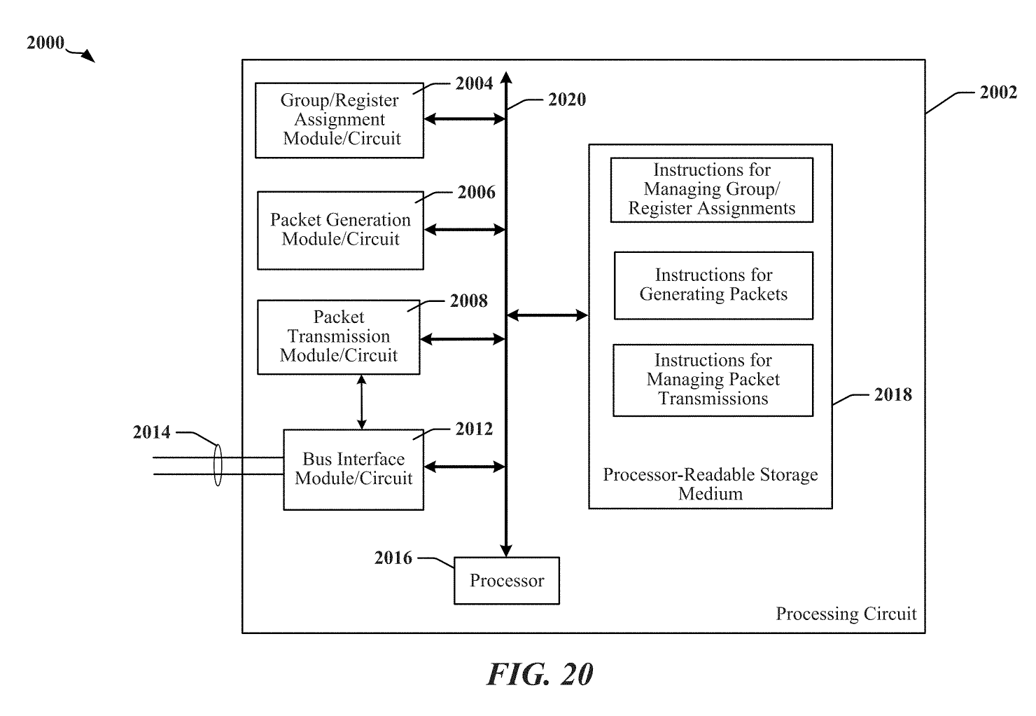

FIG. 18 is a flow chart 1800 of a method of sending data to a receiver across a serial bus interface. The method may be performed at a device operating as a transmitter/bus master (e.g., apparatus 1700 of FIG. 17 or apparatus 2000 of FIG. 20).

The device may send a group assignment command to each of a plurality of devices to associate each device with a group identifier (e.g., GSID) 1802. The device may also configure a plurality of devices by assigning each device to one or more trigger registers (e.g., TrigReg1, TrigReg2, etc.) 1804. For example, the device may send a trigger register assignment command containing a trigger identifier. The trigger assignment command may assign each device to the trigger identifier and the one or more trigger registers. In an aspect, the configuration may be performed once until a component carrier is no longer required. Even as the configured device goes to sleep, a trigger configuration (index) will not be lost.

The device may provide the group identifier in a packet to be transmitted through an interface 1806 if the packet is to trigger devices of different modules/circuits. Hence, the group identifier identifies the devices of different modules/circuits.

The device may address the packet to a trigger register 1808. At least one device of the plurality of devices is enabled for operation according to the trigger register. The at least one device may include devices of a same module/circuit. The at least one device may include devices of different modules/circuits.

The device may generate a bit-index field in the packet 1810. At least one bit in the bit-index field corresponds to the at least one device and indicates whether the at least one device is to be enabled for operation. For example, a first bit value (e.g., value of “1”) may be provided in each bit location of the bit-index field that corresponds to a device that is to be enabled for operation. Moreover, a second bit value (e.g., value of “0”) may be provided in each bit location of the bit-index field that corresponds to a device in the first set that is to remain disabled for operation. In an aspect, devices that may be logically grouped together may be enabled for operation by a same bit in the bit-index field. Notably, devices remain disabled for operation when the packet is addressed to a trigger register to which the devices are not assigned.

The device may send the packet through the interface 1812.

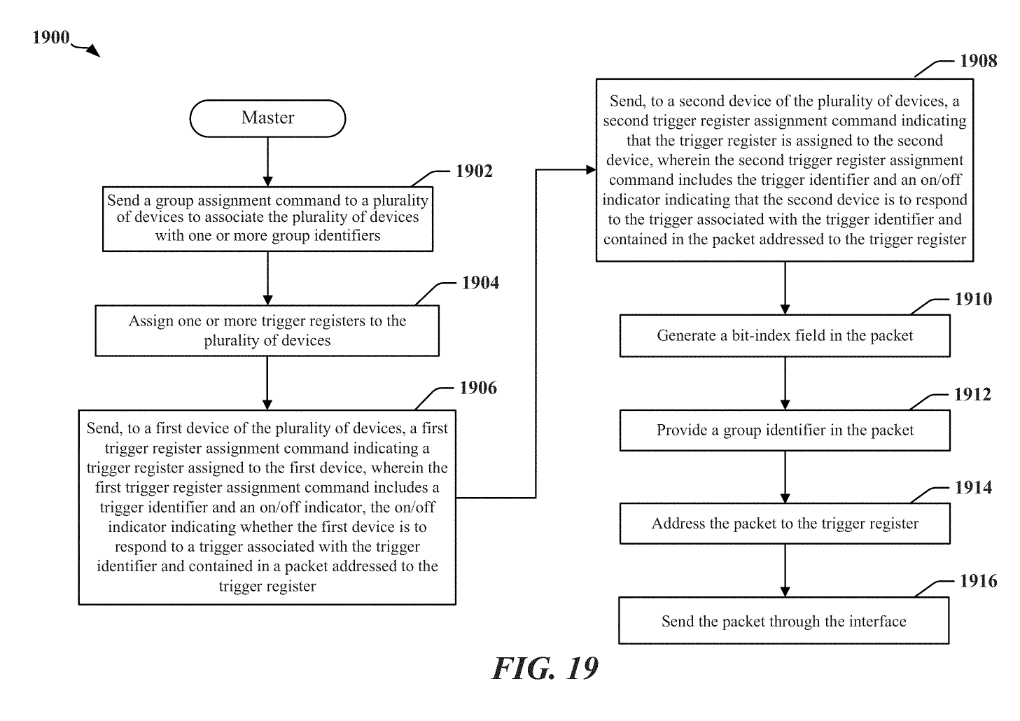

FIG. 19 is a flow chart 1900 of another method of sending data to a receiver across a serial bus interface. The method may be performed at a device operating as a transmitter/bus master (e.g., apparatus 1700 of FIG. 17 or apparatus 2000 of FIG. 20).

The device may send a group assignment command to a plurality of devices to associate the plurality of devices with one more group identifiers (e.g., GSID) 1902. In an aspect, a group identifier may overlap with other group identifiers. Hence, at least one group identifier may be associated with a device that is associated with at least one other group identifier. The device may also assign one or more trigger registers (e.g., TrigReg1, TrigReg2, etc.) to the plurality of devices 1904.

The device may send, to a first device of the plurality of devices, a first trigger register assignment command indicating a trigger register assigned to the first device 1906. The first trigger register assignment command may include a trigger identifier and an on/off indicator. The on/off indicator may indicate whether the first device is to respond to a trigger associated with the trigger identifier and contained in a packet addressed to the trigger register.

The device may also send, to a second device of the plurality of devices, a second trigger register assignment command indicating that the trigger register is assigned to the second device 1908. The second trigger register assignment command may include the trigger identifier and an on/off indicator indicating that the second device is to respond to the trigger associated with the trigger identifier and contained in the packet addressed to the trigger register.

The device may generating a bit-index field in the packet 1910. Generating the bit-index field in the packet includes providing a first bit value in each bit location of the bit-index field that corresponds to a device that is to be enabled for operation and providing a second bit value in each bit location of the bit-index field that corresponds to a device that is to remain disabled for operation.

In an aspect, at least one bit in the bit-index field corresponds to the trigger and indicates whether the first device is enabled for operation if the on/off indicator of the first trigger register assignment command indicates that the first device is to respond to the trigger. In a further aspect, the on/off indicator of the first trigger register assignment command may indicate that the first device is not to respond to the trigger. Moreover, the at least one bit in the bit-index field indicates whether the second device is enabled for operation when the on/off indicator of the second trigger register assignment command indicates that the second device is to respond to the trigger.

In an aspect, the plurality of devices are located across different modules/circuits. Accordingly, the device may provide a group identifier in the packet 1910. The group identifier may identify a set of devices of the plurality of devices across the different modules/circuits.

The device may address the packet to the trigger register 1914 and send the packet through the interface 1916.

FIG. 20 is a diagram illustrating an example of a hardware implementation for an apparatus 2000 employing a processing circuit 2002 to support operations related to one or more aspects of the disclosure (e.g., aspects related to the methods of FIGS. 18 and 19 described above). The processing circuit typically has a processor 2016 that may include one or more of a microprocessor, microcontroller, digital signal processor, a sequencer and a state machine. The processing circuit 2002 may be implemented with a bus architecture, represented generally by the bus 2020. The bus 2020 may include any number of interconnecting buses and bridges depending on the specific application of the processing circuit 2002 and the overall design constraints. The bus 2020 links together various circuits including one or more processors and/or hardware modules, represented by the processor 2016, the modules or circuits 2004, 2006, 2008, line interface circuits 2012 configurable to communicate over connectors or wires 2014 and the computer-readable storage medium 2018. The bus 2020 may also link various other circuits such as timing sources, peripherals, voltage regulators, and power management circuits, which are well known in the art, and therefore, will not be described any further.

The processor 2016 is responsible for general processing, including the execution of code/instructions stored on the computer-readable storage medium 2018. The code/instructions, when executed by the processor 2016, causes the processing circuit 2002 to perform the various functions described supra for any particular apparatus. The computer-readable storage medium may also be used for storing data that is manipulated by the processor 2016 when executing software, including data decoded from symbols transmitted over the connectors or wires 2014, which may be configured as data lanes and clock lanes. The processing circuit 2002 further includes at least one of the modules/circuits 2004, 2006, and 2008. The modules/circuits 2004, 2006, and 2008 may be software modules running in the processor 2016, resident/stored in the computer-readable storage medium 2018, one or more hardware modules coupled to the processor 2016, or some combination thereof. The modules/circuits 2004, 2006, and/or 2008 may include microcontroller instructions, state machine configuration parameters, or some combination thereof.

In one configuration, the apparatus 2000 includes a group/register assignment module and/or circuit 2004 that is configured to assign each of a plurality of devices with a group identifier and send a group assignment command to each device to associate each device with the group identifier. The group/register assignment module and/or circuit 2004 is also configured to assign each device to a trigger identifier and one or more trigger registers and send a trigger register assignment command containing the trigger identifier. The apparatus 2000 further includes a packet generation module and/or circuit 2006 that is configured to provide the group identifier in a packet to be transmitted through an interface 2012, the group identifier identifying devices of different modules/circuits, address the packet to a trigger register, wherein at least one device of the plurality of devices is enabled for operation according to the trigger register, and generate a bit-index field in the packet. The apparatus 2000 further includes a packet transmission module and/or circuit 2008 that is configured to send the packet through the interface 2012.

In another configuration, the group/register assignment module and/or circuit 2004 is configured to send a group assignment command to a plurality of devices to associate the plurality of devices with one or more group identifiers, assign one or more trigger registers to the plurality of devices, send, to a first device of the plurality of devices a first trigger register assignment command indicating a trigger register assigned to the first device, and send to a second device of the plurality of devices, a second trigger register assignment command indicating that the trigger register is assigned to the second device. The packet generation module and/or circuit 2006 is configured to generating a bit-index field in the packet and provide a group identifier in the packet. The packet transmission module and/or circuit 2008 is configured to address the packet to the trigger register and send the packet through the interface 2012.

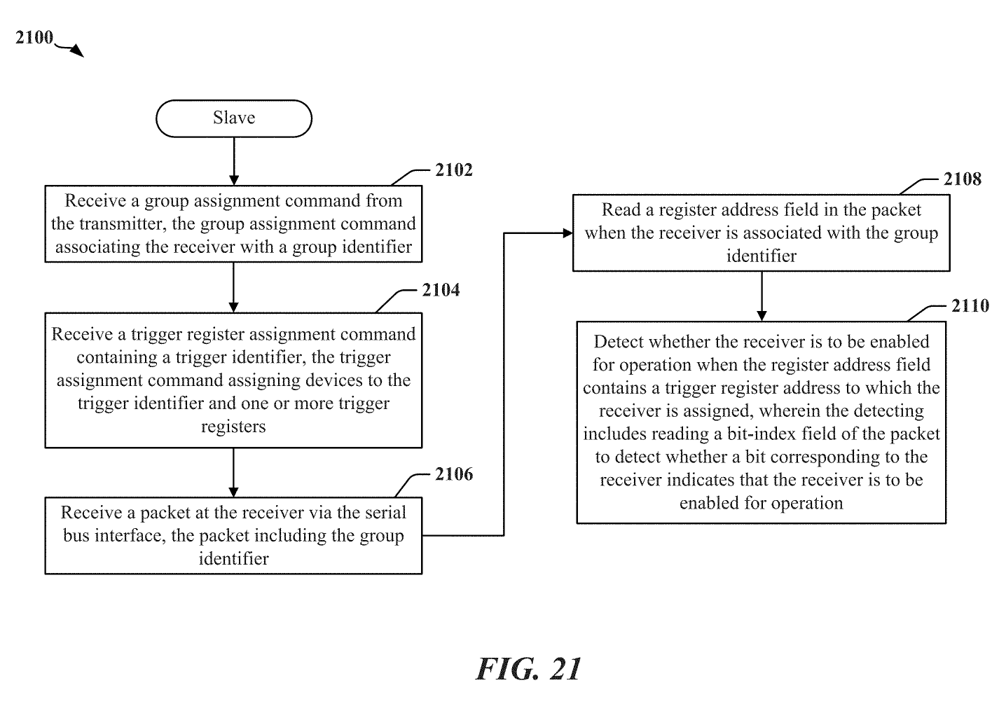

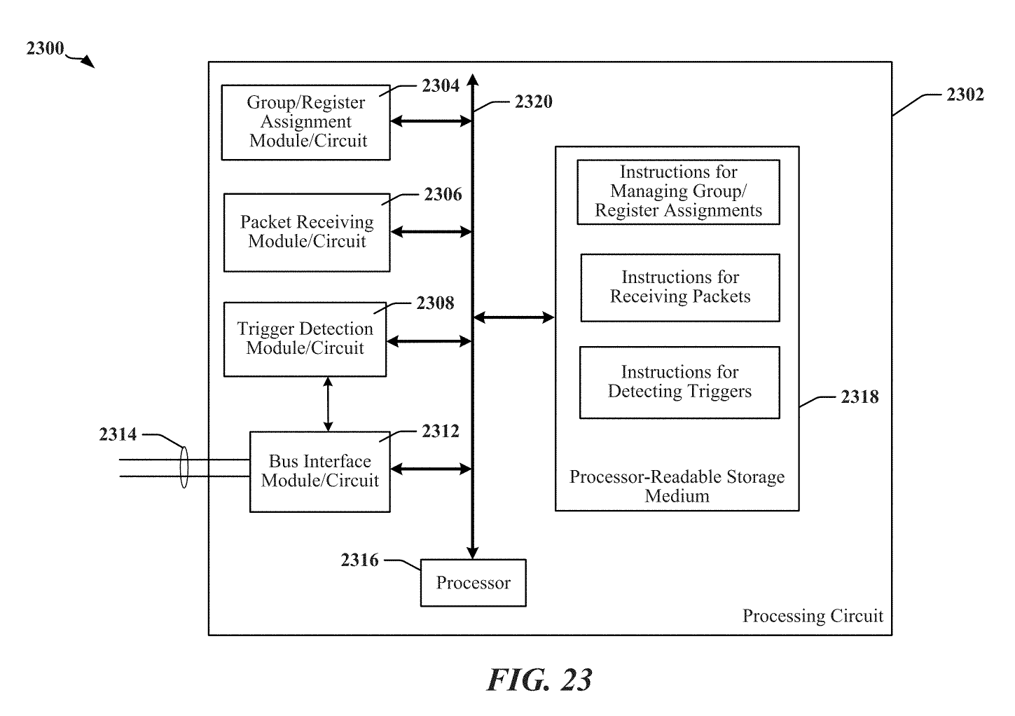

FIG. 21 is a flow chart 2100 of a method of receiving data from a transmitter across a serial bus interface. The method may be performed at a receiver/slave device coupled to a bus (e.g., apparatus 1700 of FIG. 17 or apparatus 2300 of FIG. 23).

The device may receive a group assignment command from the transmitter 2102. The group assignment command associates the device with a group identifier (e.g., GSID). The device may further receive a trigger register assignment command containing a trigger identifier 2104. The trigger assignment command assigns devices to the trigger identifier and one or more trigger registers (e.g., TrigReg1, TrigReg2, etc.).

The device may receive a packet via the serial bus interface 2106. The packet may include the group identifier. The device may read a register address field in the packet when the device is associated with the group identifier 2108.

The device may detect whether the device is to be enabled for operation when the register address field contains a trigger register address to which the device is assigned 2110. For example, the device may read a bit-index field of the packet to detect whether a bit corresponding to the device indicates that the device is to be enabled for operation. The device is to be enabled for operation when a bit location of the bit-index field corresponding to the device contains a first bit value (e.g., value of “1”). The device is to remain disabled for operation when the bit location of the bit-index field corresponding to the receiver contains a second bit value (e.g., value of “0”).

The device remains disabled for operation when the device is not associated with the group identifier. Moreover, the device remains disabled for operation when the register address field contains a trigger register address to which the device is not assigned.

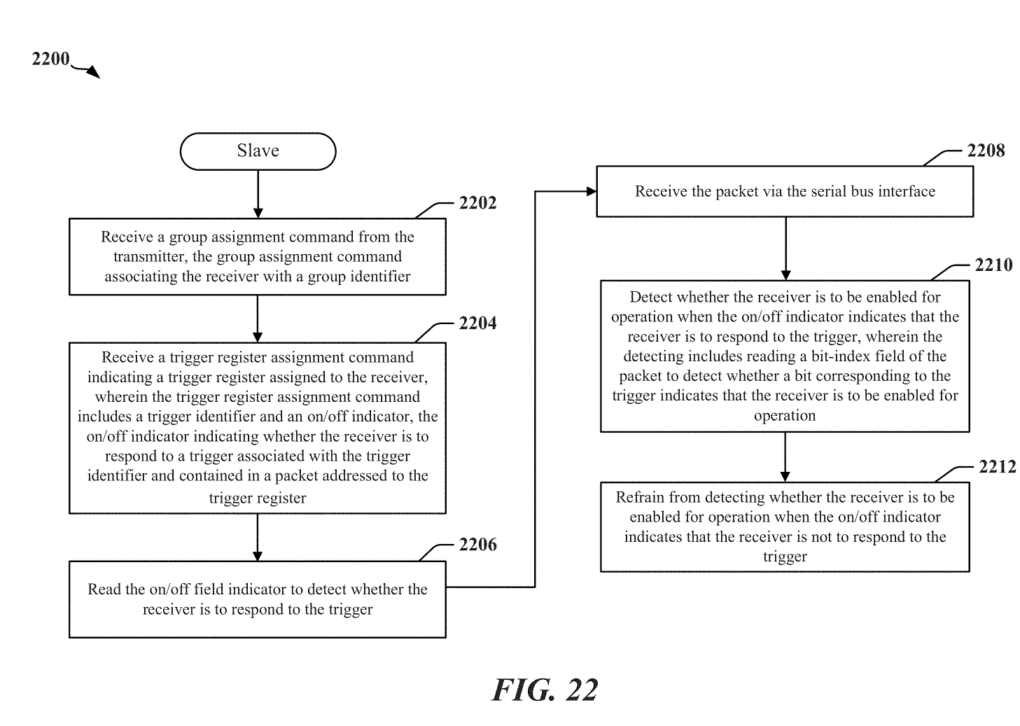

FIG. 22 is a flow chart 2200 of a method of receiving data from a transmitter across a serial bus interface. The method may be performed at a receiver/slave device coupled to a bus (e.g., apparatus 1700 of FIG. 17 or apparatus 2300 of FIG. 23).

The device may receive a group assignment command from the transmitter 2202. The group assignment command associates the device with a group identifier (e.g., GSID). The group identifier may be associated with a plurality of devices across different modules/circuits. Moreover, the group identifier may be associated with at least one device that is associated with another group identifier.

The device may receive a trigger register assignment command indicating a trigger register (e.g., TrigReg1, TrigReg2, etc.) assigned to the device 2204. The trigger register assignment command may include a trigger identifier and an on/off indicator. The on/off indicator may indicate whether the device is to respond to a trigger associated with the trigger identifier and contained in a packet addressed to the trigger register.

The device may read the on/off field indicator to detect whether the device is to respond to the trigger 2206. The device may thereafter receive the packet via the serial bus interface 2208.

The device may detect whether the device is to be enabled for operation when the on/off indicator indicates that the device is to respond to the trigger 2210. The detecting may include reading a bit-index field of the packet to detect whether a bit corresponding to the trigger indicates that the device is to be enabled for operation. In an aspect, the device reads the bit-index field when the packet includes the group identifier associated with the device. The device is to be enabled for operation when a bit location of the bit-index field corresponding to the trigger identifier contains a first bit value. The device is to remain disabled for operation when the bit location of the bit-index field corresponding to the trigger identifier contains a second bit value.

The device may refrain from detecting whether the device is to be enabled for operation when the on/off indicator indicates that the device is not to respond to the trigger 2212.

FIG. 23 is a diagram illustrating an example of a hardware implementation for an apparatus 2300 employing a processing circuit 2302 to support operations related to one or more aspects of the disclosure (e.g., aspects related to the methods of FIGS. 21 and 22 described above). The processing circuit typically has a processor 2316 that may include one or more of a microprocessor, microcontroller, digital signal processor, a sequencer and a state machine. The processing circuit 2302 may be implemented with a bus architecture, represented generally by the bus 2320. The bus 2320 may include any number of interconnecting buses and bridges depending on the specific application of the processing circuit 2302 and the overall design constraints. The bus 2320 links together various circuits including one or more processors and/or hardware modules, represented by the processor 2316, the modules or circuits 2304, 2306, 2308, line interface circuits 2312 configurable to communicate over connectors or wires 2314 and the computer-readable storage medium 2318. The bus 2320 may also link various other circuits such as timing sources, peripherals, voltage regulators, and power management circuits, which are well known in the art, and therefore, will not be described any further.

The processor 2316 is responsible for general processing, including the execution of code/instructions stored on the computer-readable storage medium 2318. The code/instructions, when executed by the processor 2316, causes the processing circuit 2302 to perform the various functions described supra for any particular apparatus. The computer-readable storage medium may also be used for storing data that is manipulated by the processor 2316 when executing software, including data decoded from symbols transmitted over the connectors or wires 2314, which may be configured as data lanes and clock lanes. The processing circuit 2302 further includes at least one of the modules/circuits 2304, 2306, and 2308. The modules/circuits 2304, 2306, and 2308 may be software modules running in the processor 2316, resident/stored in the computer-readable storage medium 2318, one or more hardware modules coupled to the processor 2316, or some combination thereof. The modules/circuits 2304, 2306, and/or 2308 may include microcontroller instructions, state machine configuration parameters, or some combination thereof.

In one configuration, the apparatus 2300 includes a group/register assignment module and/or circuit 2304 that is configured to receive a group assignment command from the transmitter, wherein the group assignment command associates a device with a group identifier, and receive a trigger register assignment command containing a trigger identifier, wherein the trigger assignment command assigns devices to the trigger identifier and one or more trigger registers. The apparatus 2300 further includes a packet receiving module and/or circuit 2306 that is configured to receive a packet via the bus interface 2312. The apparatus 2300 also includes a trigger detection module and/or circuit 2308 that is configured to read a register address field in the packet when the device is associated with the group identifier and detect whether the device is to be enabled for operation when the register address field contains a trigger register address to which the device is assigned.

In another configuration, the group/register assignment module and/or circuit 2304 is configured to receive a group assignment command from the transmitter, the group assignment command associating the receiver with a group identifier, and receive a trigger register assignment command indicating a trigger register assigned to the receiver. The packet receiving module and/or circuit 2306 is configured to receive a packet via the serial bus interface. The trigger detection module and/or circuit 2308 is configured to read an on/off field indicator of the packet to detect whether the receiver is to respond to a trigger, detect whether the receiver is to be enabled for operation when the on/off indicator indicates that the receiver is to respond to the trigger, and refrain from detecting whether the receiver is to be enabled for operation when the on/off indicator indicates that the receiver is not to respond to the trigger.

Exemplary Operating Environment for Loading Data into Devices and Triggering Devices to Enable Data

According to certain aspects of the disclosure, when a bus master sends a trigger on the RFFE bus, all slave devices linked with the trigger may at the same time be enabled for operation upon receiving the trigger in order to minimize latency. For example, upon receiving the trigger, all slave devices on the RFFE bus having data associated with the trigger may simultaneously enable/activate the data. In some aspects, the data associated with the trigger may be received by a device prior to receiving the trigger. In other aspects, the data associated with the trigger may be received by the device within a same command frame, or within a same transaction, as receiving the trigger.

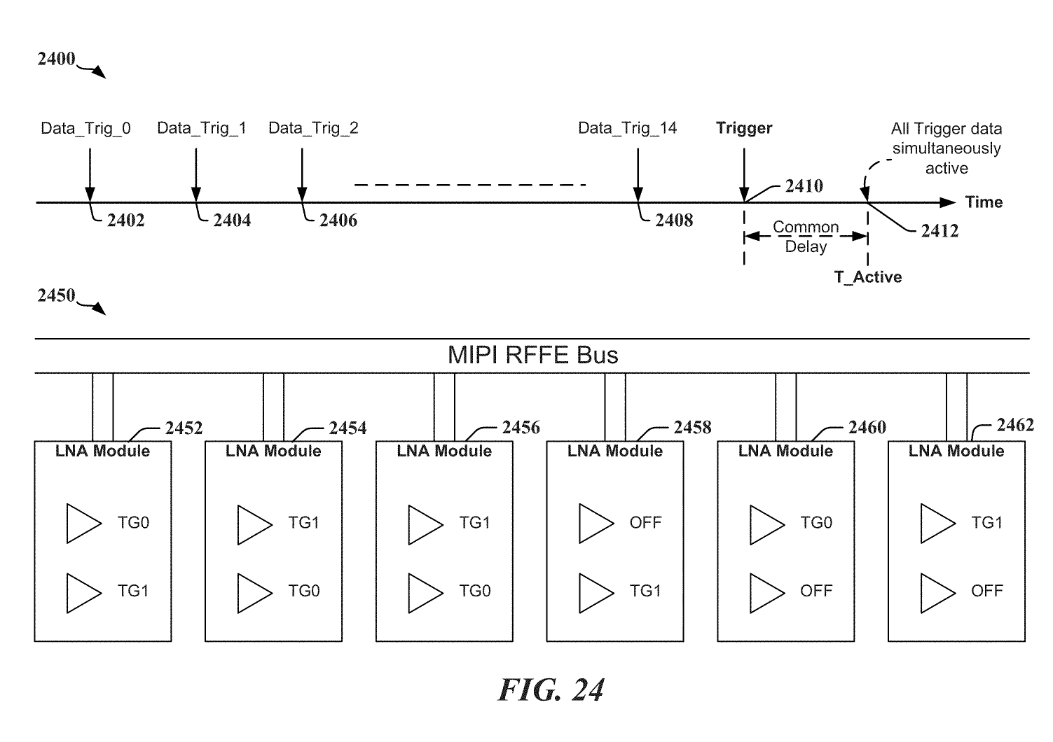

FIG. 24 illustrates a timeline 2400 detailing device reception of data associated with different triggers. In an aspect, data for a number of different triggers may be received by the device. For example, 15 possible data values for 15 possible triggers may be received. As shown in the timeline 2400, the 15 possible data values may be referred to as Data_Trig_0, Data_Trig_1, Data_Trig_2, . . . , and Data_Trig_14. The 15 possible triggers may be part of the same trigger group.

In an aspect, each data value may be 1-byte (8-bit) in length. Accordingly, a total of 15 bytes of data for 15 possible different/unique triggers may be sent from the bus master to the slave device at 15 different time points. As shown in the timeline 2400, a first data value (Data_Trig_0) associated with a first trigger (Trig_0) may be sent/received at a first time point 2402. A second data value (Data_Trig_1) associated with a second trigger (Trig_1) may be sent/received at a second time point 2404. A third data value (Data_Trig_2) associated with a third trigger (Trig_2) may be sent/received at a third time point 2406. A fifteenth data value (Data_Trig_14) associated with a fifteenth trigger (Trig_14) may be sent/received at a fifteenth time point 2408. Although not shown, fourth through fourteenth data values (Data_Trig_3 through Data_Trig_13) respectively associated with fourth through fourteenth triggers (Trig_3 through Trig_13) may be sent/received at different time points in between the third time point 2406 and the fifteenth time point 2408. Each data value may be sent/received via one or more packets/datagrams.

In an aspect, once all of the data values have been sent/received, a data packet containing all triggers may be sent/received. For example, as shown in the timeline 2400, sometime after the fifteenth data value (Data_Trig_14) is sent/received at the fifteenth time point 2408, a common data packet/datagram containing all 15 triggers associated with the first through fifteenth data values (Data_Trig_0 through Data_Trig_14) may be sent/received at a time point 2410. Thereafter, after a common delay (e.g., delay common to all devices on the RFFE bus and based on a master-supplied clock), all devices receiving the common data packet may simultaneously enable/activate all previously received data at a time point 2412. Hence, after the delay, all the data that was previously sent across the RFFE bus become active (get effective) at the same time, meaning that the data is used to perform the task the data was intended to perform on different devices simultaneously.

In an aspect, each device (e.g., LNA) receiving the different data values associated with the different triggers may store the data values in a shadow register. Each device may have its own shadow register. The shadow register provides a device location where the received data may temporarily reside before being activated by the reception of an associated trigger. The data stored in the shadow register remains idle while waiting for the associated trigger to arrive. Once the associated trigger arrives, the device passes on the data stored in the shadow register to an actual action point of the device hardware so that the data becomes effective (enabled/active). All data will become effective at the same time.

In an aspect, each trigger may correspond to one shadow register location. Moreover, each shadow register location may be limited to 1-byte (8-bit) in length. Accordingly, the shadow register may be understood to be a number of 1-byte (8-bit) locations where the received data values corresponding to the different triggers may be stored.

In a further aspect, the data values for the different triggers (e.g., 15 possible triggers) may be received and stored in corresponding shadow register locations. However, if the data values for a specific group of triggers are to be stored in contiguous register locations in the shadow register, then the data values may be combined in one packet/datagram by the bus master and sent to the slave device. For example, if the three data values Data_Trig_0, Data_Trig_1, and Data_Trig_2 (i.e., 3-byte of data) are to be stored in three contiguous register locations in the shadow register, then all 3-byte of data may be sent/received in one packet/datagram. In such an aspect, the timeline 2400 may be viewed as a scenario where none of the different data values are to be placed in contiguous shadow register locations, and therefore, the different data values are sent/received at 15 different time points in 15 different packets/datagrams Regardless of how the different data values for the different triggers are sent/received, all data values for the different triggers may be enabled/activated using one datagram containing all the different triggers.

FIG. 24 further includes a diagram 2450 illustrating device modules/circuits on a RFFE bus implementing a triggering scheme. In an aspect of the disclosure, a triggering scheme may define a number of trigger groups (TGs), wherein a trigger group (TG) contains different triggers for triggering different data values. For example, a first trigger group TG0 may be defined to include all the triggers Trig_0 to Trig_14 respectively associated with the data values Data_Trig_0 to Data_Trig_14 received in the timeline 2400. In a further example, a second trigger group TG1 may be defined to include other triggers associated with other data values (not shown). Each device (e.g., LNA) on the RFFE bus may be assigned to respond to a trigger group.

The first trigger group TG0 may be associated with a first group ID. Moreover, a first common trigger command (e.g., first register_write command) may be associated with the first group ID. Accordingly, when the first common trigger command is sent, devices on the RFFE bus associated with the first group ID having data associated with the triggers contained in the first trigger group TG0 will enable/activate the data upon receiving the first common trigger command. All other devices remain disabled with respect to the first trigger command.

Similarly, the second trigger group TG1 may be associated with a second group ID and a second common trigger command (e.g., second register_write command) may be associated with the second group ID. Accordingly, when the second common trigger command is sent, devices on the RFFE bus associated with the second group ID having data associated with the triggers contained in the second trigger group TG1 will enable/activate the data upon receiving the second common trigger command. All other devices remain disabled with respect to the second trigger command.

Referring to the diagram 2450, device modules/circuits 2452, 2454, 2456, 2458, 2460, and 2462 may include devices that are associated with the first group ID and/or the second group ID. Each device within a device module/circuit may be configured to respond to a specific trigger group. For example, a first device in the device module/circuit 2452, a second device in the device module/circuit 2454, a second device in the device module/circuit 2456, and a first device in the device module/circuit 2460 may be configured to respond to the first trigger group TG0. In another example, a second device in the device module/circuit 2452, a first device in the device module/circuit 2454, a first device in the device module/circuit 2456, a second device in the device module/circuit 2458, and a first device in the device module/circuit 2462 may be configured to respond to the second trigger group TG1.

Each device may respond to a common trigger command that contains a matching group ID. For example, as mentioned above, the first common trigger command associated with the first group ID is a first register_write command. Accordingly, when the first common trigger command is sent, the first device in the device module/circuit 2452, the second device in the device module/circuit 2454, the second device in the device module/circuit 2456, and the first device in the device module/circuit 2460 having data associated with the triggers contained in the first trigger group TG0 will enable/activate the data upon receiving the first common trigger command. In a further example, as mentioned above, the second common trigger command associated with the second group ID is a second register_write command. Accordingly, when the second common trigger command is sent, the second device in the device module/circuit 2452, the first device in the device module/circuit 2454, the first device in the device module/circuit 2456, the second device in the device module/circuit 2458, and the first device in the device module/circuit 2462 having data associated with the triggers contained in the second trigger group TG1 will enable/activate the data upon receiving the second common trigger command.

In an aspect, a trigger command may be sent in one common datagram using a unique slave identifier (USID) or a group slave identifier (GSID). The USID may be used to target one known receiver on the RFFE bus, and hence, the sent datagram cannot be received or used by more than one device. Alternatively, the GSID may be used to target multiple slave devices in a group, and hence, the sent datagram may be received or used by the multiple slaves in the group across multiple device modules/circuits. As such, the trigger command is sent to the multiple devices on the RFFE bus all at once and used across the multiple devices, and after a common delay (which is the same for all devices), earlier sent trigger data becomes simultaneously effective.

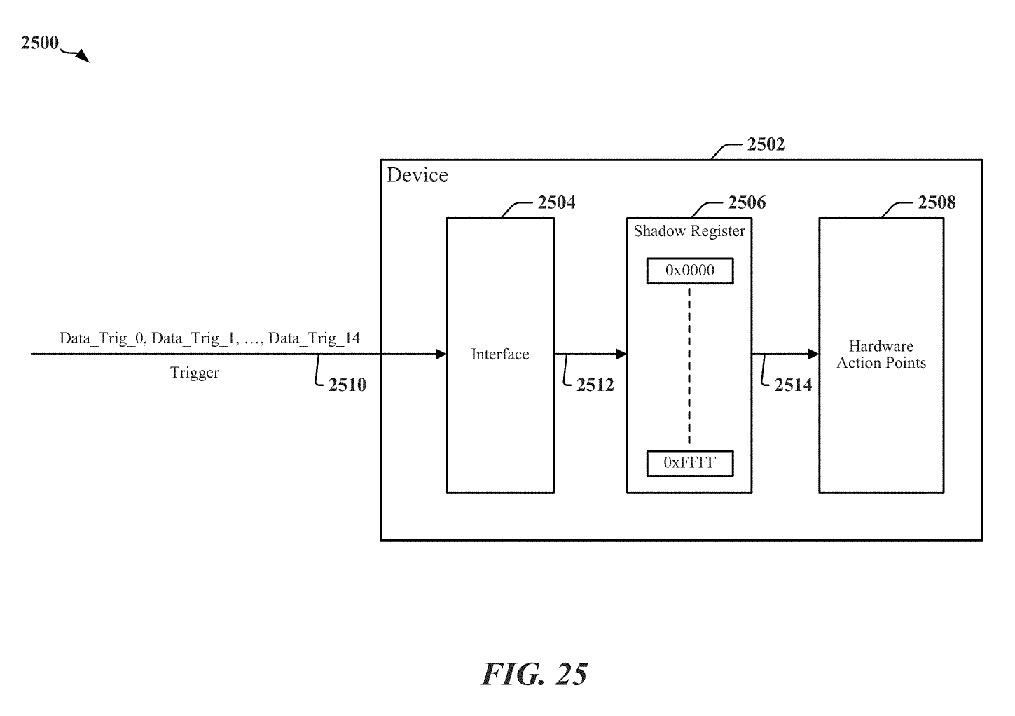

FIG. 25 is a diagram 2500 illustrating an example of a hardware implementation for a slave device (e.g., LNA) 2502 supporting operations related to one or more aspects of the disclosure (e.g., aspects related to FIG. 24 described above). The device 2502 may include an interface 2504, a shadow register 2506, and one or more hardware action points 2508.

In an example operation, the interface 2504 may receive different data values for different triggers via a RFFE bus 2510. As mentioned above, 15 possible data values for 15 possible triggers may be received, for example. Accordingly, the interface 2504 may receive the data values Data_Trig_0, Data_Trig_1, Data_Trig_14 via the RFFE bus 2510.

Upon receiving the data values, the device 2502 may store 2512 the data in the shadow register 2506. In the shadow register 2506, the received data may temporarily reside before being activated by the reception of an associated trigger. Hence, the data stored in the shadow register 2506 remains idle while waiting for the associated trigger to arrive.

The interface 2504 may receive a trigger command via the RFFE bus 2510. The trigger command may contain all the triggers associated with the received data. Accordingly, upon receiving the trigger command, the device 2502 may pass 2514 the data stored in the shadow register 2506 to one or more actual hardware action points 2508 to enable/activate the data, wherein all of the previously received data becomes enabled/active at the same time.

### Further Examples of Methods and Processing Circuits

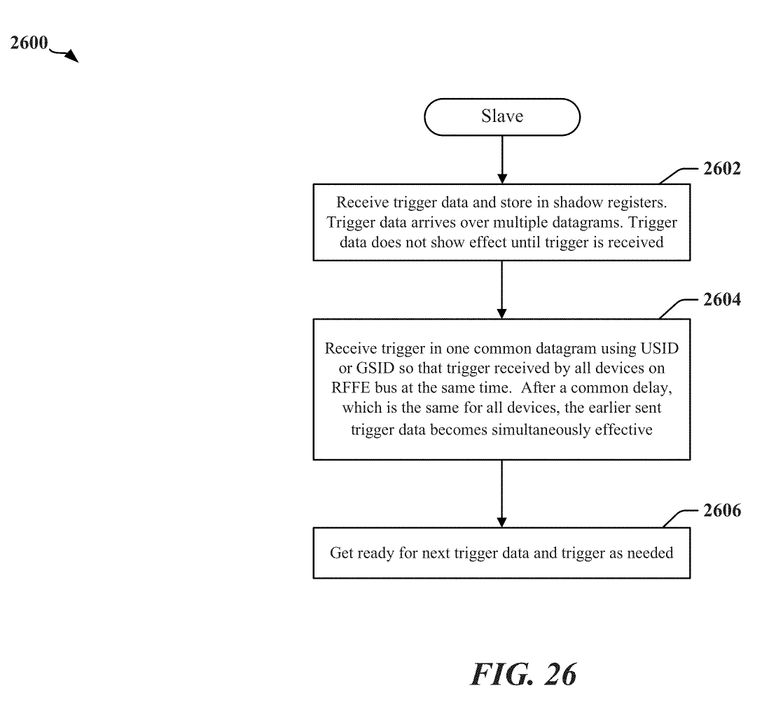

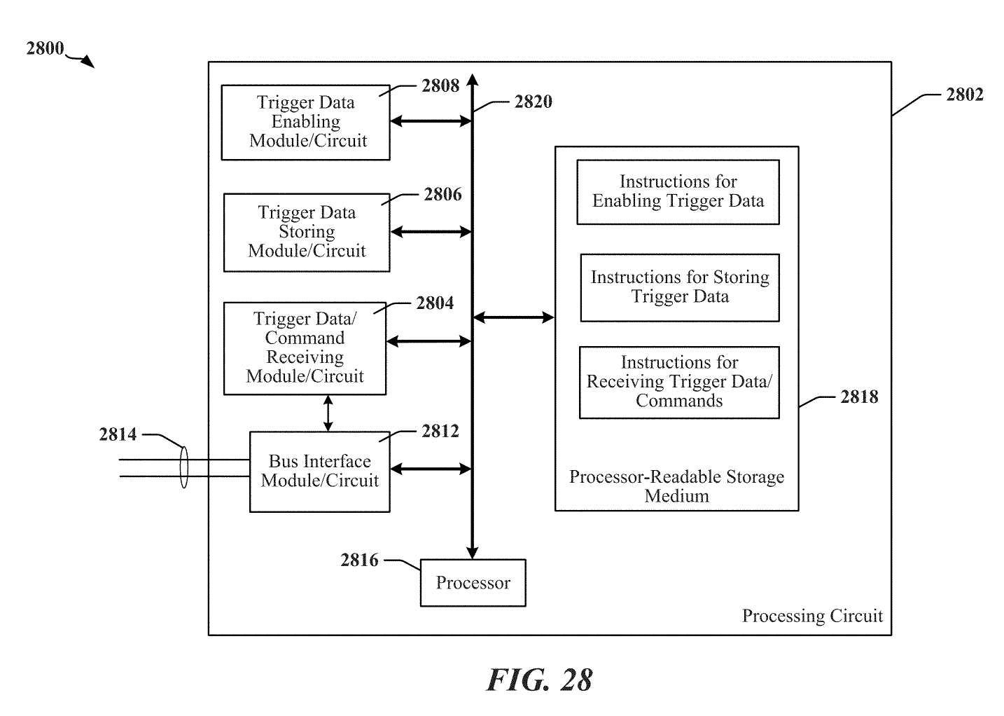

FIG. 26 is a flow chart 2600 of a method of receiving trigger data and a corresponding trigger from a sending device across a serial bus interface. The method may be performed at a receiver/slave device coupled to a bus (e.g., apparatus 1700 of FIG. 17, apparatus 2300 of FIG. 23, or apparatus 2800 of FIG. 28).

The device may receive trigger data via a RFFE bus and store the received trigger data in shadow register locations 2602. In an aspect, the trigger data is received over multiple datagrams. Moreover, the trigger data does not show an effect until a trigger is received.

The device may receive the trigger in one common datagram using USID or GSID 2604. The one common datagram is used so that the trigger is received by all devices on the RFFE bus at the same time. After a common delay, which may be the same for all devices, previously received trigger data becomes simultaneously effective.

After the triggering of the data, the device may get ready for a next transmission of trigger data and a corresponding trigger as needed 2606.

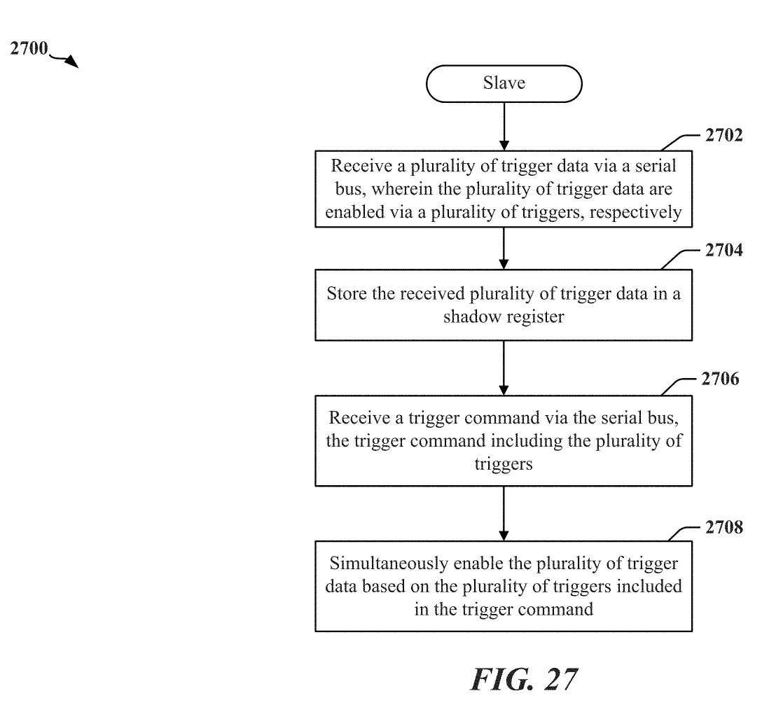

FIG. 27 is a flow chart 2700 of a method for receiving data from a sending device across a serial bus. The method may be performed at a receiving device/slave device coupled to a bus (e.g., apparatus 1700 of FIG. 17, apparatus 2300 of FIG. 23, or apparatus 2800 of FIG. 28).

The receiving device may receive a plurality of trigger data via a serial bus, wherein the plurality of trigger data are enabled via a plurality of triggers, respectively 2702. In an aspect, the plurality of trigger data are received via a single datagram. In another aspect, the plurality of trigger data are received via a plurality of datagrams, respectively.

The receiving device may further store the received plurality of trigger data in a shadow register 2704. The received plurality of trigger data are idle in the shadow register until a trigger command is received. In an aspect, the plurality of trigger data are stored in respective register locations in the shadow register. In a further aspect, the if plurality of trigger data are received via a single datagram, then the plurality of trigger data may be stored in respective register locations that are consecutive to each other in the shadow register.

The receiving device may receive a trigger command via the serial bus 2706. The trigger command includes the plurality of triggers. Moreover, the trigger command may be received via a single datagram. In an aspect, at least one trigger data of the plurality of trigger data and the trigger command may be received in a same datagram.

The receiving device may simultaneously enable the plurality of trigger data based on the plurality of triggers included in the trigger command 2708. In an aspect, the plurality of trigger data may be simultaneously enabled after a delay common to all devices coupled to the serial bus.

FIG. 28 is a diagram illustrating an example of a hardware implementation for an apparatus 2800 employing a processing circuit 2802 to support operations related to one or more aspects of the disclosure (e.g., aspects related to the methods of FIGS. 26 and 27 described above). The processing circuit typically has a processor 2816 that may include one or more of a microprocessor, microcontroller, digital signal processor, a sequencer and a state machine. The processing circuit 2802 may be implemented with a bus architecture, represented generally by the bus 2820. The bus 2820 may include any number of interconnecting buses and bridges depending on the specific application of the processing circuit 2802 and the overall design constraints. The bus 2820 links together various circuits including one or more processors and/or hardware modules, represented by the processor 2816, the modules or circuits 2804, 2806, 2808, line interface circuits 2812 configurable to communicate over connectors or wires 2814 and the computer-readable storage medium 2818. The bus 2820 may also link various other circuits such as timing sources, peripherals, voltage regulators, and power management circuits, which are well known in the art, and therefore, will not be described any further.

The processor 2816 is responsible for general processing, including the execution of code/instructions stored on the computer-readable storage medium 2818. The code/instructions, when executed by the processor 2816, causes the processing circuit 2802 to perform the various functions described supra for any particular apparatus. The computer-readable storage medium may also be used for storing data that is manipulated by the processor 2816 when executing software, including data decoded from symbols transmitted over the connectors or wires 2814, which may be configured as data lanes and clock lanes. The processing circuit 2802 further includes at least one of the modules/circuits 2804, 2806, and 2808. The modules/circuits 2804, 2806, and 2808 may be software modules running in the processor 2816, resident/stored in the computer-readable storage medium 2818, one or more hardware modules coupled to the processor 2816, or some combination thereof. The modules/circuits 2804, 2806, and/or 2808 may include microcontroller instructions, state machine configuration parameters, or some combination thereof.

In one configuration, the apparatus 2800 includes a trigger data/command receiving module and/or circuit 2804 that is configured to receive a plurality of trigger data via a serial bus through the interface 2812, wherein the plurality of trigger data are enabled via a plurality of triggers, respectively, and configured to receive a trigger command via the serial bus through the interface 2812, the trigger command including the plurality of triggers. The apparatus 2800 further includes a trigger data storing module and/or circuit 2806 that is configured to store the received plurality of trigger data in a shadow register. The apparatus 2800 also includes a trigger data enabling module and/or circuit 2808 that is configured to simultaneously enable the plurality of trigger data based on the plurality of triggers included in the trigger command.

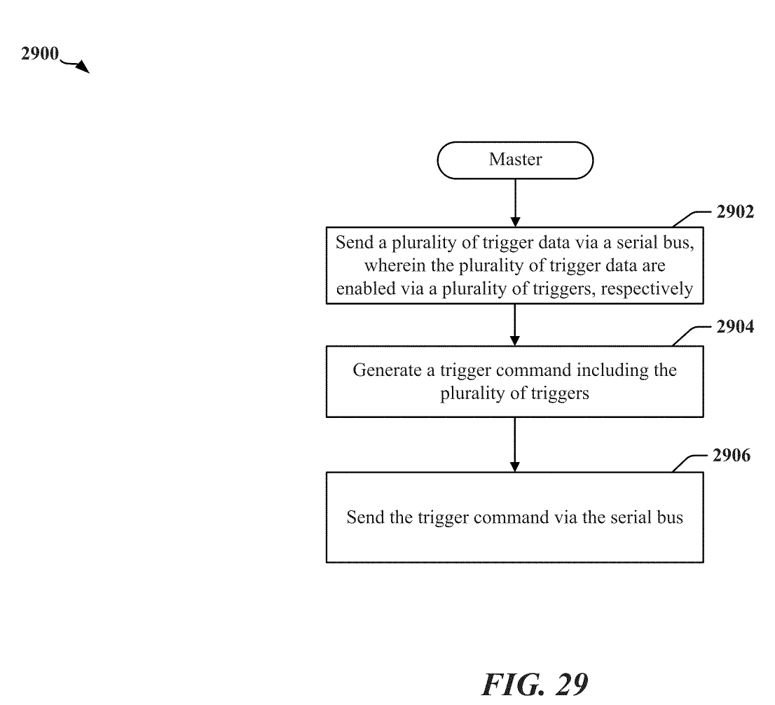

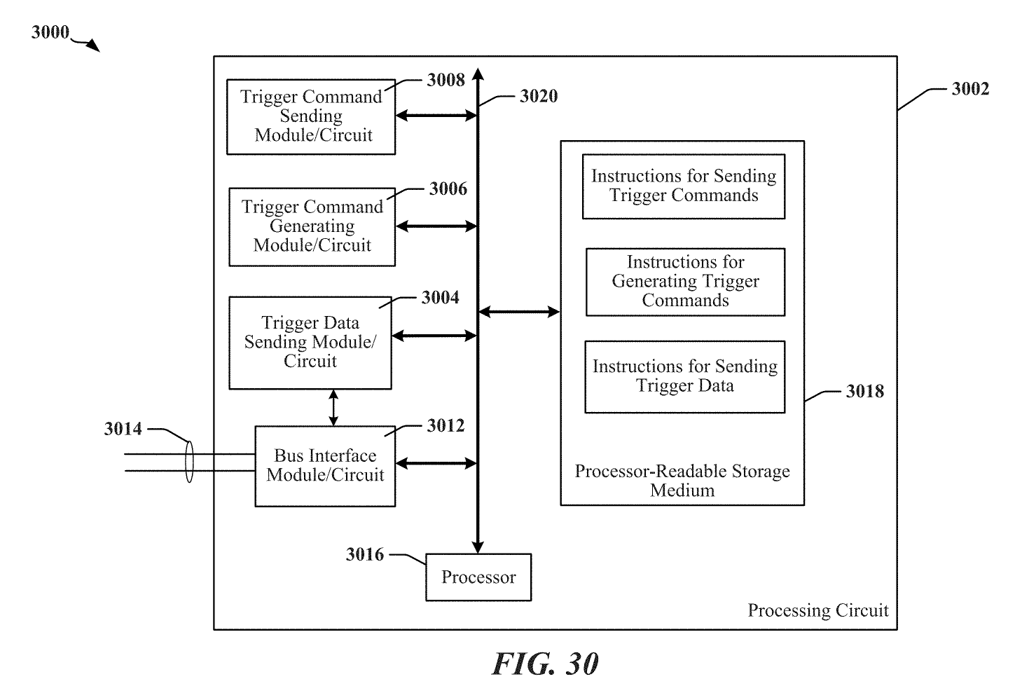

FIG. 29 is a flow chart 2900 of a method of sending data to a receiver across a serial bus interface. The method may be performed at a device operating as a sending device/bus master (e.g., apparatus 1700 of FIG. 17, apparatus 2000 of FIG. 20, or apparatus 3000 of FIG. 30).

The device may send a plurality of trigger data via a serial bus, wherein the plurality of trigger data are enabled via a plurality of triggers, respectively 2902. In an aspect, the plurality of trigger data are sent via a plurality of datagrams, respectively. In another aspect, the plurality of trigger data are sent via a single datagram.

The device may generate a trigger command including the plurality of triggers 2904. The device may further send the trigger command via the serial bus 2906. The trigger command is sent via a single datagram to simultaneously enable the plurality of trigger data based on the plurality of triggers included in the trigger command. In an aspect, at least one trigger data of the plurality of trigger data and the trigger command are sent in a same datagram.

FIG. 30 is a diagram illustrating an example of a hardware implementation for an apparatus 3000 employing a processing circuit 3002 to support operations related to one or more aspects of the disclosure (e.g., aspects related to the method of FIG. 29 described above). The processing circuit typically has a processor 3016 that may include one or more of a microprocessor, microcontroller, digital signal processor, a sequencer and a state machine. The processing circuit 3002 may be implemented with a bus architecture, represented generally by the bus 3020. The bus 3020 may include any number of interconnecting buses and bridges depending on the specific application of the processing circuit 3002 and the overall design constraints. The bus 3020 links together various circuits including one or more processors and/or hardware modules, represented by the processor 3016, the modules or circuits 3004, 3006, 3008, line interface circuits 3012 configurable to communicate over connectors or wires 3014 and the computer-readable storage medium 3018. The bus 3020 may also link various other circuits such as timing sources, peripherals, voltage regulators, and power management circuits, which are well known in the art, and therefore, will not be described any further.

The processor 3016 is responsible for general processing, including the execution of code/instructions stored on the computer-readable storage medium 3018. The code/instructions, when executed by the processor 3016, causes the processing circuit 3002 to perform the various functions described supra for any particular apparatus. The computer-readable storage medium may also be used for storing data that is manipulated by the processor 3016 when executing software, including data decoded from symbols transmitted over the connectors or wires 3014, which may be configured as data lanes and clock lanes. The processing circuit 3002 further includes at least one of the modules/circuits 3004, 3006, and 3008. The modules/circuits 3004, 3006, and 3008 may be software modules running in the processor 3016, resident/stored in the computer-readable storage medium 3018, one or more hardware modules coupled to the processor 3016, or some combination thereof. The modules/circuits 3004, 3006, and/or 3008 may include microcontroller instructions, state machine configuration parameters, or some combination thereof.

In one configuration, the apparatus 3000 includes a trigger data sending module and/or circuit 3004 that is configured to send a plurality of trigger data via a serial bus through the interface 3012, wherein the plurality of trigger data are enabled via a plurality of triggers, respectively. The apparatus 3000 further includes a trigger command generating module and/or circuit 3006 that is configured to generate a trigger command including the plurality of triggers. The apparatus 3000 also includes a trigger command sending module and/or circuit 3008 that is configured to send the trigger command via the serial bus through the interface 3012.

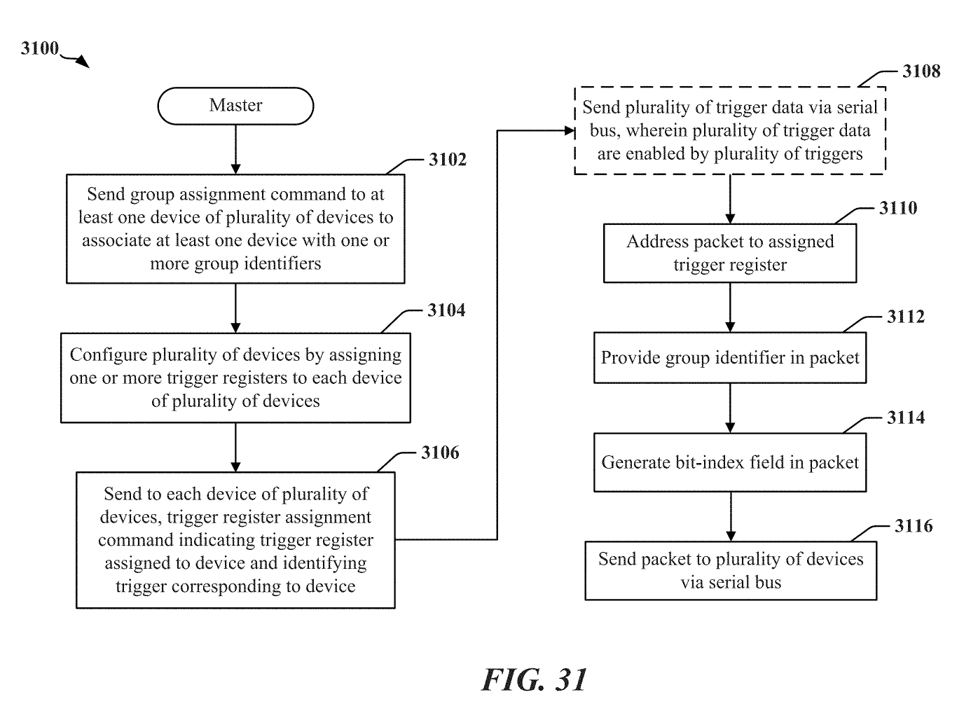

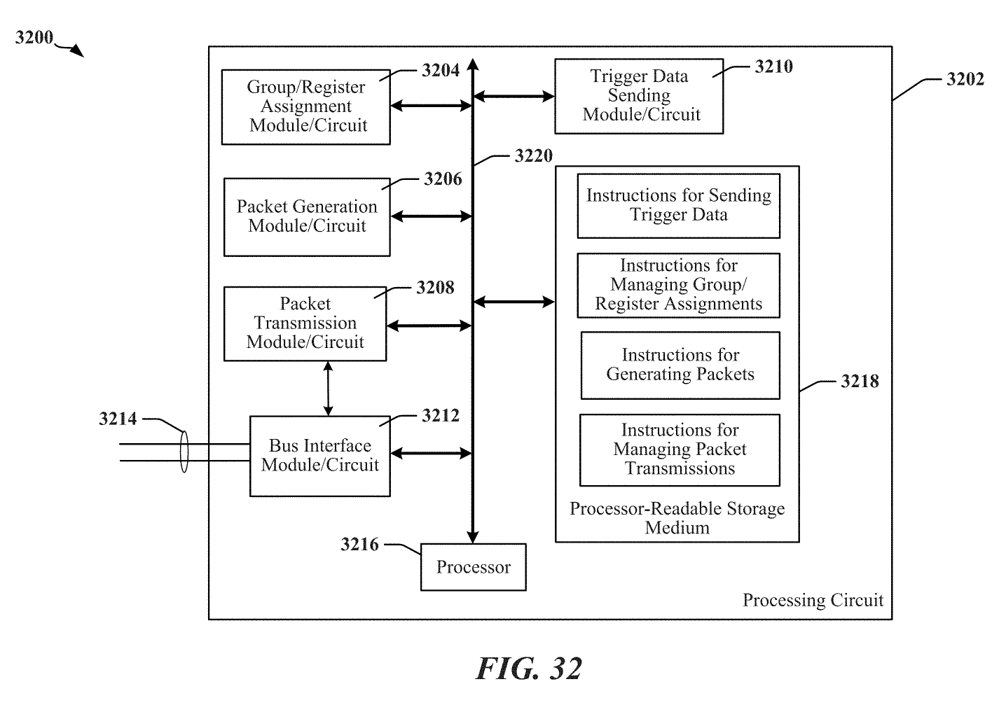

FIG. 31 is a flow chart 3100 of a method of sending data to a receiver across a serial bus. The method may be performed at a device operating as a transmitter/bus master (e.g., apparatus 1700 of FIG. 17 or apparatus 3200 of FIG. 32).

The transmitter may send a group assignment command to at least one device of a plurality of devices to associate the at least one device with one or more group identifiers (e.g., GSID) 3102. The transmitter may also configure the plurality of devices by assigning one or more trigger registers (e.g., TrigReg1, TrigReg2, Reg0x1A, Reg0x1B, etc.) to each device of the plurality of devices 3104. For example, the transmitter may send to each device of the plurality of devices, a trigger register assignment command indicating a trigger register assigned to a device and identifying a trigger corresponding to the device 3106. In an aspect, the configuration may be performed once until a component carrier is no longer required. Even as the configured device goes to sleep, a trigger configuration (index) will not be lost.

The transmitter may optionally send a plurality of trigger data via the serial bus 3108. The plurality of trigger data may be enabled by a plurality of triggers, respectively.

The transmitter may generate a packet an address the packet to an assigned trigger register 3110. As such, only devices on the serial bus that are associated with the assigned trigger register may be affected by the packet. Moreover, at least one device of the plurality of devices may remain disabled for operation when the packet is addressed to a trigger register to which the at least one device is not associated.

In an aspect, the plurality of devices includes devices of different modules. Accordingly, the transmitter may provide a group identifier in the packet to identify the devices of different modules 3112. As such, only devices on the serial bus that are associated with the group identifier may be affected by the packet. Moreover, at least one device of the plurality of devices may remain disabled for operation when the packet contains a group identifier to which the at least one device is not associated.

The transmitter may generate a bit-index field in the packet 3114. Bits in the bit-index field may respectively represent triggers corresponding to devices associated with the assigned trigger register. Moreover, each bit may indicate whether one or more corresponding devices are enabled for operation. The bits in the bit-index field may further respectively represent triggers corresponding to devices associated with the group identifier. Generating the bit-index field in the packet may include providing a first bit value (e.g., value of “1”) in each bit location of the bit-index field that corresponds to one or more devices that are to be enabled for operation and providing a second bit value (e.g., value of “0”) in each bit location of the bit-index field that corresponds to one or more devices that are to remain disabled for operation. Devices that are logically grouped together may be enabled for operation by a same bit in the bit-index field.

The transmitter may send the packet to the plurality of devices via the serial bus 3116. In an aspect, the bits in the bit-index field of the packet respectively represent the plurality of triggers associated with the plurality of trigger data optionally sent (step 3108) by the transmitter. Accordingly, the packet may be sent (step 3116) to simultaneously enable the plurality of trigger data based on the bits in the bit-index field.

FIG. 32 is a diagram illustrating an example of a hardware implementation for an apparatus 3200 employing a processing circuit 3202 to support operations related to one or more aspects of the disclosure (e.g., aspects related to the method of FIG. 31 described above). The processing circuit typically has a processor 3216 that may include one or more of a microprocessor, microcontroller, digital signal processor, a sequencer and a state machine. The processing circuit 3202 may be implemented with a bus architecture, represented generally by the bus 3220. The bus 3220 may include any number of interconnecting buses and bridges depending on the specific application of the processing circuit 3202 and the overall design constraints. The bus 3220 links together various circuits including one or more processors and/or hardware modules, represented by the processor 3216, the modules or circuits 3204, 3206, 3208, 3210, line interface circuits 3212 configurable to communicate over connectors or wires 3214 and the computer-readable storage medium 3218. The bus 3220 may also link various other circuits such as timing sources, peripherals, voltage regulators, and power management circuits, which are well known in the art, and therefore, will not be described any further.

The processor 3216 is responsible for general processing, including the execution of code/instructions stored on the computer-readable storage medium 3218. The code/instructions, when executed by the processor 3216, causes the processing circuit 3202 to perform the various functions described supra for any particular apparatus. The computer-readable storage medium may also be used for storing data that is manipulated by the processor 3216 when executing software, including data decoded from symbols transmitted over the connectors or wires 3214, which may be configured as data lanes and clock lanes. The processing circuit 3202 further includes at least one of the modules/circuits 3204, 3206, 3208, and 3210. The modules/circuits 3204, 3206, 3208, and 3210 may be software modules running in the processor 3216, resident/stored in the computer-readable storage medium 3218, one or more hardware modules coupled to the processor 3216, or some combination thereof. The modules/circuits 3204, 3206, 3208, and/or 3210 may include microcontroller instructions, state machine configuration parameters, or some combination thereof.

In one configuration, the apparatus 3200 includes a group/register assignment module and/or circuit 3204 that is configured to configure a plurality of devices by assigning one or more trigger registers each device of the plurality of devices, send to each device of the plurality of devices, a trigger register assignment command indicating a trigger register assigned to a device and identifying a trigger corresponding to the device, and send a group assignment command to at least one device of the plurality of devices to associate the at least one device with one or more group identifiers. The apparatus 3200 further includes a packet generation module and/or circuit 3206 that is configured to address a packet to an assigned trigger register, generate a bit-index field in the packet, wherein bits in the bit-index field respectively represent triggers corresponding to devices associated with the assigned trigger register, and wherein each bit indicates whether one or more corresponding devices are enabled for operation, and provide a group identifier in the packet, wherein the group identifier identifies devices of different modules, and wherein the bits in the bit-index field further respectively represent triggers corresponding to devices associated with the group identifier. The apparatus 3200 further includes a packet transmission module and/or circuit 3208 that is configured to send the packet through the interface 3212 to the plurality of devices. The apparatus 3200 also includes a trigger data sending module and/or circuit 3208 that is configured to send a plurality of trigger data via the interface 3212.

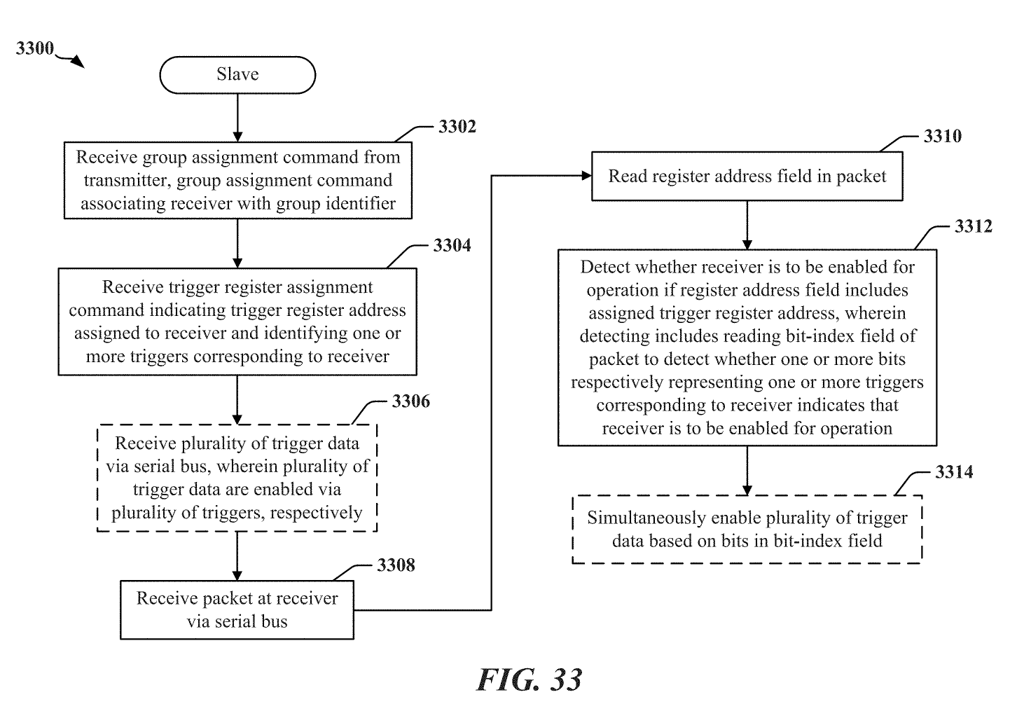

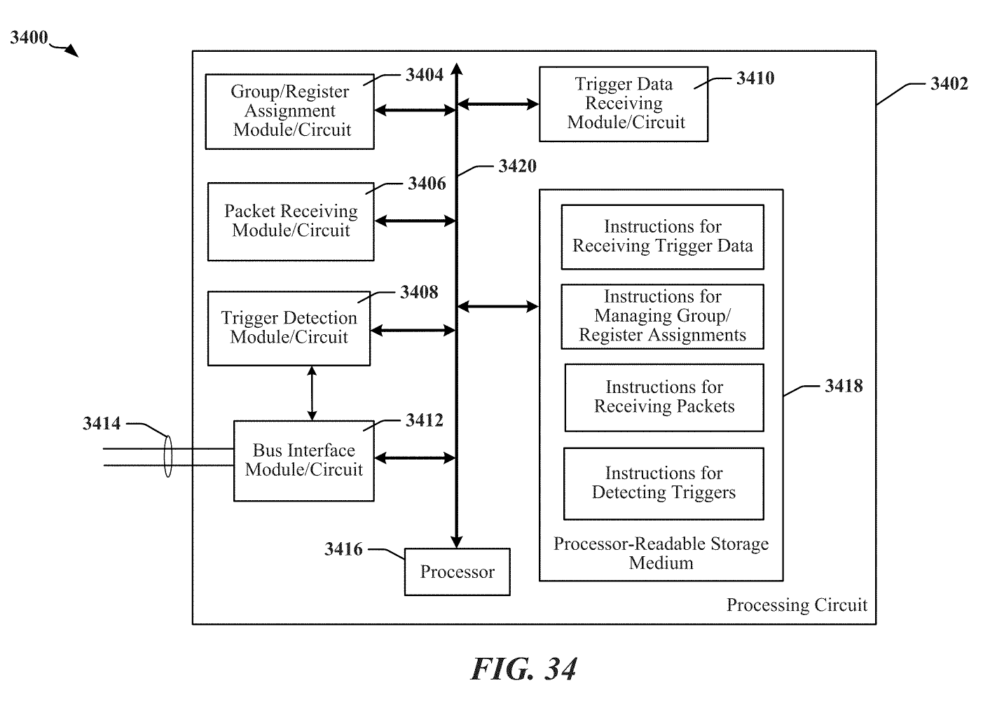

FIG. 33 is a flow chart 3300 of a method of receiving data from a transmitter across a serial bus. The method may be performed at a receiver/slave device coupled to a bus (e.g., apparatus 1700 of FIG. 17 or apparatus 3400 of FIG. 34).

The receiver may receive a group assignment command from the transmitter 3302. The group assignment command associates the device with a group identifier (e.g., GSID). The receiver may further receive a trigger register assignment command 3304. The trigger assignment command may indicate a trigger register address assigned to the receiver and identify one or more triggers corresponding to the receiver.

The receiver may optionally receive a plurality of trigger data via the serial bus 3306. The plurality of trigger data may be enabled via a plurality of triggers, respectively.

The receiver may receive a packet at the receiver via the serial bus 3308. Moreover, the receiver may read a register address field in the packet 3310. In an aspect, the packet includes the group identifier. The group identifier may identify a group of devices of different modules. Accordingly, the receiver may read the register address field when the receiver is associated with the group identifier. Moreover, the receiver may remain disabled for operation when the receiver is not associated with the group identifier.

The receiver may detect whether the receiver is to be enabled for operation if the register address field includes an assigned trigger register address 3312. The receiver may remain disabled for operation when the register address field does not contain the trigger register address assigned to the receiver. To detect whether the receiver is enabled for operation, the receiver may read a bit-index field of the packet to detect whether one or more bits respectively representing the one or more triggers corresponding to the receiver indicates that the receiver is to be enabled for operation. The receiver may be enabled for operation when one or more bit locations of the bit-index field corresponding to the receiver contains a first bit value (e.g., value of “1”). The receiver may remain disabled for operation when the one or more bit locations of the bit-index field corresponding to the receiver contains a second bit value (e.g., value of “0”).

In an aspect, the bits in the bit-index field of the packet respectively represent the plurality of triggers associated with the plurality of trigger data optionally received (step 3306) by the receiver. Accordingly, the received packet may facilitate the receiver to simultaneously enable the plurality of trigger data based on the bits in the bit-index field 3314. The plurality of trigger data may be simultaneously enabled after a delay common to all devices coupled to the serial bus.

FIG. 34 is a diagram illustrating an example of a hardware implementation for an apparatus 3400 employing a processing circuit 3402 to support operations related to one or more aspects of the disclosure (e.g., aspects related to the method of FIG. 33 described above). The processing circuit typically has a processor 3416 that may include one or more of a microprocessor, microcontroller, digital signal processor, a sequencer and a state machine. The processing circuit 3402 may be implemented with a bus architecture, represented generally by the bus 3420. The bus 3420 may include any number of interconnecting buses and bridges depending on the specific application of the processing circuit 3402 and the overall design constraints. The bus 3420 links together various circuits including one or more processors and/or hardware modules, represented by the processor 3416, the modules or circuits 3404, 3406, 3408, 3410, line interface circuits 3412 configurable to communicate over connectors or wires 3414 and the computer-readable storage medium 3418. The bus 3420 may also link various other circuits such as timing sources, peripherals, voltage regulators, and power management circuits, which are well known in the art, and therefore, will not be described any further.

The processor 3416 is responsible for general processing, including the execution of code/instructions stored on the computer-readable storage medium 3418. The code/instructions, when executed by the processor 3416, causes the processing circuit 3402 to perform the various functions described supra for any particular apparatus. The computer-readable storage medium may also be used for storing data that is manipulated by the processor 3416 when executing software, including data decoded from symbols transmitted over the connectors or wires 3414, which may be configured as data lanes and clock lanes. The processing circuit 3402 further includes at least one of the modules/circuits 3404, 3406, 3408, and 3410. The modules/circuits 3404, 3406, 3408, and 3410 may be software modules running in the processor 3416, resident/stored in the computer-readable storage medium 3418, one or more hardware modules coupled to the processor 3416, or some combination thereof. The modules/circuits 3404, 3406, 3408, and/or 3410 may include microcontroller instructions, state machine configuration parameters, or some combination thereof.

In one configuration, the apparatus 3400 includes a group/register assignment module and/or circuit 3404 that is configured to receive a group assignment command from the transmitter, wherein the group assignment command associates a device with a group identifier, and receive a trigger register assignment command indicating a trigger register address assigned to the receiver and identifying one or more triggers corresponding to the receiver. The apparatus 3400 further includes a packet receiving module and/or circuit 3406 that is configured to receive a packet via the bus interface 3412. The apparatus 3400 also includes a trigger detection module and/or circuit 3408 that is configured to read a register address field in the packet and detect whether the device is to be enabled for operation if the register address field includes an assigned trigger register address, wherein the detecting includes reading a bit-index field of the packet to detect whether one or more bits respectively representing the one or more triggers corresponding to the receiver indicates that the receiver is to be enabled for operation. The apparatus 3400 further includes a trigger data receiving module and/or circuit that is configured to receive a plurality of trigger data via the bus interface 3412, wherein the plurality of trigger data are enabled via a plurality of triggers, respectively, wherein bits in the bit-index field of the packet respectively represent the plurality of triggers, and wherein the trigger detection module and/or circuit 3408 simultaneously enables the plurality of trigger data based on the bits in the bit-index field.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method performed at a transmitter for sending data to a receiver across a serial bus, comprising:
configuring a plurality of devices by assigning one or more trigger registers to each device of the plurality of devices;
sending to each device of the plurality of devices, a trigger register assignment command indicating a trigger register assigned to a device and identifying a trigger corresponding to the device;
addressing a packet to an assigned trigger register;
generating a bit-index field in the packet, wherein bits in the bit-index field respectively represent triggers corresponding to devices associated with the assigned trigger register, and wherein each bit indicates whether one or more corresponding devices are enabled for operation; and
sending the packet to the plurality of devices via the serial bus.

2. The method of claim 1, wherein the plurality of devices includes devices of different modules, the method further including:
providing a group identifier in the packet, wherein the group identifier identifies the devices of different modules, and wherein the bits in the bit-index field further respectively represent triggers corresponding to devices associated with the group identifier.

3. The method of claim 2, further including:
sending a group assignment command to at least one device of the plurality of devices to associate the at least one device with one or more group identifiers.

4. The method of claim 2, wherein at least one device of the plurality of devices remains disabled for operation when the packet contains a group identifier to which the at least one device is not associated.

5. The method of claim 1, wherein generating the bit-index field in the packet includes:
providing a first bit value in each bit location of the bit-index field that corresponds to one or more devices that are to be enabled for operation; and
providing a second bit value in each bit location of the bit-index field that corresponds to one or more devices that are to remain disabled for operation.

6. The method of claim 1, wherein devices that are logically grouped together are enabled for operation by a same bit in the bit-index field.

7. The method of claim 1, wherein at least one device of the plurality of devices remains disabled for operation when the packet is addressed to a trigger register to which the at least one device is not associated.

8. The method of claim 1, further including:
sending a plurality of trigger data via the serial bus, wherein the plurality of trigger data are enabled by a plurality of triggers, respectively,
wherein the bits in the bit-index field of the packet respectively represent the plurality of triggers, and
wherein the packet is sent to simultaneously enable the plurality of trigger data based on the bits in the bit-index field.

9. A transmitter for sending data to a receiver across a serial bus, comprising:
a serial bus interface; and
a processing circuit configured to:
configure a plurality of devices by assigning one or more trigger registers each device of the plurality of devices,
send to each device of the plurality of devices, a trigger register assignment command indicating a trigger register assigned to a device and identifying a trigger corresponding to the device,
address a packet to an assigned trigger register,
generate a bit-index field in the packet, wherein bits in the bit-index field respectively represent triggers corresponding to devices associated with the assigned trigger register, and wherein each bit indicates whether one or more corresponding devices are enabled for operation, and
send the packet to the plurality of devices through the serial bus interface.

10. The transmitter of claim 9, wherein the plurality of devices includes devices of different modules, the processing circuit further configured to:
provide a group identifier in the packet, wherein the group identifier identifies the devices of different modules, and wherein the bits in the bit-index field further respectively represent triggers corresponding to devices associated with the group identifier.

11. The transmitter of claim 10, the processing circuit further configured to:
send a group assignment command to at least one device of the plurality of devices to associate the at least one device with one or more group identifiers.

12. The transmitter of claim 10, wherein at least one device of the plurality of devices remains disabled for operation when the packet contains a group identifier to which the at least device is not associated.

13. The transmitter of claim 9, wherein the processing circuit configured to generate the bit-index field in the packet is further configured to:
provide a first bit value in each bit location of the bit-index field that corresponds to one or more devices that are to be enabled for operation; and
provide a second bit value in each bit location of the bit-index field that corresponds to one or more devices that are to remain disabled for operation.

14. The transmitter of claim 9, wherein devices that are logically grouped together are enabled for operation by a same bit in the bit-index field.

15. The transmitter of claim 9, wherein at least one device of the plurality of devices remains disabled for operation when the packet is addressed to a trigger register to which the at least one device is not associated.

16. The transmitter of claim 9, the processing circuit further configured to:
send a plurality of trigger data via the serial bus interface, wherein the plurality of trigger data are enabled by a plurality of triggers, respectively,
wherein the bits in the bit-index field of the packet respectively represent the plurality of triggers, and
wherein the packet is sent to simultaneously enable the plurality of trigger data based on the bits in the bit-index field.

17. A method performed at a receiver for receiving data from a transmitter across a serial bus, comprising:
receiving a trigger register assignment command indicating a trigger register address assigned to the receiver and identifying one or more triggers corresponding to the receiver;
receiving a packet at the receiver via the serial bus;
reading a register address field in the packet; and
detecting whether the receiver is to be enabled for operation if the register address field includes an assigned trigger register address,
wherein the detecting includes reading a bit-index field of the packet to detect whether one or more bits respectively representing the one or more triggers corresponding to the receiver indicates that the receiver is to be enabled for operation.

18. The method of claim 17, wherein:
the receiver is to be enabled for operation when one or more bit locations of the bit-index field corresponding to the receiver contains a first bit value; and
the receiver is to remain disabled for operation when the one or more bit locations of the bit-index field corresponding to the receiver contains a second bit value.

19. The method of claim 17, wherein the packet includes a group identifier identifying a group of devices of different modules, and wherein the register address field is read when the receiver is associated with the group identifier.

20. The method of claim 19, further including:
receiving a group assignment command from the transmitter, the group assignment command associating the receiver with the group identifier.

21. The method of claim 19, wherein:
the receiver remains disabled for operation when the receiver is not associated with the group identifier; and
the receiver remains disabled for operation when the register address field does not contain the assigned trigger register address.

22. The method of claim 17, further including:
receiving a plurality of trigger data via the serial bus, wherein the plurality of trigger data are enabled via a plurality of triggers, respectively,
wherein bits in the bit-index field of the packet respectively represent the plurality of triggers; and
simultaneously enabling the plurality of trigger data based on the bits in the bit-index field.

23. The method of claim 22, wherein the plurality of trigger data are simultaneously enabled after a delay common to all devices coupled to the serial bus.

24. A receiver for receiving data from a transmitter across a serial bus, comprising:
a serial bus interface; and
a processing circuit configured to:
receive a trigger register assignment command indicating a trigger register address assigned to the receiver and identifying one or more triggers corresponding to the receiver,
receive a packet at the receiver via the serial bus interface;
read a register address field in the packet, and
detect whether the receiver is to be enabled for operation if the register address field includes an assigned trigger register address,
wherein the processing circuit is configured to detect by reading a bit-index field of the packet to detect whether one or more bits respectively representing the one or more triggers corresponding to the receiver indicates that the receiver is to be enabled for operation.

25. The receiver of claim 24, wherein:
the receiver is to be enabled for operation when one or more bit locations of the bit-index field corresponding to the receiver contains a first bit value; and
the receiver is to remain disabled for operation when the one or more bit locations of the bit-index field corresponding to the receiver contains a second bit value.

26. The receiver of claim 24, wherein the packet includes a group identifier identifying a group of devices of different modules, and wherein the register address field is read when the receiver is associated with the group identifier.

27. The receiver of claim 26, the processing circuit further configured to:
receive a group assignment command from the transmitter, the group assignment command associating the receiver with the group identifier.

28. The receiver of claim 26, wherein:
the receiver remains disabled for operation when the receiver is not associated with the group identifier; and
the receiver remains disabled for operation when the register address field does not contain the assigned trigger register address.

29. The receiver of claim 24, the processing circuit further configured to:
receive a plurality of trigger data via the serial bus, wherein the plurality of trigger data are enabled via a plurality of triggers, respectively,
wherein bits in the bit-index field of the packet respectively represent the plurality of triggers; and
simultaneously enable the plurality of trigger data based on the bits in the bit-index field.

30. The receiver of claim 29, wherein the plurality of trigger data are simultaneously enabled after a delay common to all devices coupled to the serial bus.
